(19) United States
(12) Patent Application Publication
(10) Pub. No.: US 2026/0056277 A1
(43) Pub. Date: Feb. 26, 2026

(54) NON-TERRESTRIAL NETWORK-BASED USER EQUIPMENT LOCATION VERIFICATION

(71) Applicant: Lenovo (Singapore) Pte. Ltd., Singapore (SG)

(72) Inventors: Robin Rajan Thomas, Bad Nauheim (DE); Sher Ali Cheema, Ilmenau (DE); Majid Ghanbarinejad, Chicago, IL (US); Vijay Nangia, Woodridge, IL (US); Dimitrios Karampatsis, Ruislip (GB); Konstantinos Samdanis, Munich (DE)

(21) Appl. No.: 19/102,802

(22) PCT Filed: Sep. 15, 2022
(86) PCT No.: PCT/EP2022/075652

§ 371 Date: Feb. 10, 2025

(30) Foreign Application Priority Data
Aug. 10, 2022 (GR) 20220100671

(51) Int. Cl. G01S 5/02; G01S 19/48; H04W 4/029; H04W 64/00; H04W 84/06

(52) U.S. Cl. CPC G01S 5/0263; G01S 5/0236; G01S 5/0244; G01S 19/48; H04W 4/029; H04W 64/00; H04W 84/06

(57) ABSTRACT

Various aspects of the present disclosure relate to NTN-based UE location verification. A network entity is configured to transmit a request for location information associated with a user equipment (UE), receive, from a base station, a first location estimate of the UE, receive, from a second network entity, a second location estimate of the UE, and perform location verification based at least in part on the first location estimate of the UE and the second location estimate of the UE.

### FIELD

The subject matter disclosed herein relates generally to wireless communications and more particularly relates to non-terrestrial network (“NTN”)-based user equipment (“UE”) location verification.

### BACKGROUND

In wireless networks, UE positioning may refer to technology that is used in the wireless network to determine the geographic location, position, and/or velocity of a UE. Due to the large coverage areas exhibited by NTN cells, conventional terrestrial network positioning verification mechanisms may not be applicable to NTN systems.

### BRIEF SUMMARY

Disclosed are solutions for NTN-based UE location verification. The solutions may be implemented by apparatus, systems, methods, or computer program products.

In one embodiment, a first apparatus includes a transceiver and a processor coupled to the transceiver. In one embodiment, the processor is configured to cause the apparatus to transmit a RAT-independent location information request, the request comprising a location configuration for a NG-RAN node, receive RAT-independent location information of a target UE corresponding to the transmitted location information request, the RAT-independent location information comprising a location estimate of the target UE, trigger a location server to determine a location estimate for the target UE using a RAT-dependent positioning indication, receive the location estimate based on the RAT-dependent positioning indication, and perform verification of the received RAT-independent target UE location with respect to the RAT-dependent UE location estimate.

In one embodiment, a first method transmits a RAT-independent location information request, the request comprising a location configuration for a NG-RAN node, receives RAT-independent location information of a target UE corresponding to the transmitted location information request, the RAT-independent location information comprising a location estimate of the target UE, triggers a location server to determine a location estimate for the target UE using a

RAT-dependent positioning indication, receives the location estimate based on the RAT-dependent positioning indication, and performs verification of the received RAT-independent target UE location with respect to the RAT-dependent UE location estimate.

In one embodiment, the second apparatus includes a transceiver and a processor coupled to the transceiver. In one embodiment, the processor is configured to cause the apparatus to receive, from an AMF, an indication to determine a location estimate for the target UE using a RAT-dependent positioning indication, estimate the location of the target UE using the RAT-dependent positioning indication, and transmit, to the AMF, a response message comprising the estimated location of the target UE, a location service identifier, a positioning method that was used to estimate the location, and a timestamp of the location estimate.

In one embodiment, a second method receives, from an AMF, an indication to determine a location estimate for the target UE using a RAT-dependent positioning indication, estimate the location of the target UE using the RAT-dependent positioning indication, and transmit, to the AMF, a response message comprising the estimated location of the target UE, a location service identifier, a positioning method that was used to estimate the location, and a timestamp of the location estimate.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for NTN-based UE location verification;

FIG. 2 is a block diagram illustrating one embodiment of a 5G NR protocol stack;

FIG. 3 depicts one embodiment of NR Beam-based Positioning;

FIG. 4A depicts one embodiment of downlink time difference of arrival (“DL-TDOA”) Assistance Data;

FIG. 4B depicts one embodiment of DL-TDOA Measurement Report;

FIG. 5 depicts one embodiment of the overall architecture for UE positioning applicable to new generation radio access network (“NG-RAN”);

FIG. 6 depicts one embodiment of location service support by NG-RAN;

FIG. 7 depicts one embodiment of an NG-RAN location reporting procedure;

FIG. 8A depicts one embodiment of a networking-RAN architecture with transparent satellite;

FIG. 8B depicts one embodiment of a regenerative satellite without inter-satellite links (“ISLs”) and a gNB processed payload;

FIG. 8C depicts one embodiment of a regenerative satellite with ISLs and a gNB processed payload;

FIG. 9 depicts one embodiment a procedure for NTN-based NG-RAN location reporting;

FIG. 10 depicts one embodiment of a procedure for AMF-initiated location verification;

FIG. 11A depicts one embodiment of multi-satellite connectivity using transparent payload architecture;

FIG. 11B depicts one embodiment of multi-satellite connectivity using regenerative payload architecture;

FIG. 11C depicts one embodiment of TN and NTN connectivity using transparent payload architecture;

FIG. 11D depicts one embodiment of TN and NTN connectivity using transparent payload architecture using different AMFs and LMFs

FIG. 12 is a block diagram illustrating one embodiment of a user equipment apparatus that may be used for NTN-based UE location verification;

FIG. 13 is a block diagram illustrating one embodiment of a network apparatus that may be used for NTN-based UE location verification;

FIG. 14 is a flowchart diagram illustrating one embodiment of a method for NTN-based UE location verification; and

FIG. 15 is a flowchart diagram illustrating one embodiment of another method for NTN-based UE location verification.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for NTN-based UE location verification. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

There are no conventional methods that exist to enable the verification of a UE's reported location in an NTN network deployment. Due to the large coverage areas exhibited by NTN cells, a conventional terrestrial network mechanism may not be applicable to NTN systems. Furthermore, the conclusions of TR 38.882 have identified the need to define a network-based solution which aims at verifying the reported UE location information, due to the unreliability or lack of availability of the UE reported location. Depending on the configured positioning method, the network verification procedures would need to be enhanced to provide accurate, reliable, and low-latency verified UE location considering the satellite movement, wider range, higher Doppler shift. The present disclosure provides a set of procedural enhancements to enable support of radio access technology (“RAT”)-dependent (network-based) network verification procedures over an NTN network.

There are no known mechanisms to verify the accuracy and reliability UE's location based on NTN RAT-dependent positioning methods because existing methods have been designed with terrestrial networks in mind. According to Solution #18 of TR 23.700-030, the location verification is performed using the network data analytics function (“NWDAF”) network entity, which enables the access and mobility management function (“AMF”) to receive statistics and predictions on the UE location, hence making it easier to determine whether the potentially inaccurate location information provided by the UE is reliable and trustable or not. This solution mainly does not consider the location management function (“LMF”) in the network verification procedure of the UE and has high signaling overhead. According to Solution #24 of TR 23.700-030, NG-RAN assistance information is used to verify the UE's location, however this solution does not consider the details of this NG-RAN assistance information and how the AMF can trigger the LMF to initiated NTN RAT-dependent location verification procedures.

The problem that the solutions herein solve is support for procedures including triggers, service requests, configuration and reporting procedures for network verified location after UE initial access and registration procedures. The present disclosure describes apparatuses, methods and systems, which detail the solutions and set of procedural enhancements to enable support of NTN RAT-dependent (network-based) network verification procedures over a network.

The proposed solutions enable an enhanced location reporting configuration by the NTN NG-RAN node through suitable triggering and configuration by the AMF. This provides the AMF with an enhanced UE reported location mechanism, which can be then utilized for triggering the LMF to initiate NTN RAT-dependent location procedures. Various implementation options are detailed in which the AMF may verify the location of the UE using the response from the LMF. In another embodiment, the location reporting and network verification procedures are detailed for various NTN multi-connectivity options including transparent, regenerative, and terrestrial and non-terrestrial network combinations.

In one embodiment, a method to enable to NG-RAN location request and reporting triggered by the AMF for verification of the UE's location in an NTN deployment is disclosed. This includes different RAT-independent location configurations for reporting of the UE's location without LMF involvement. This reported UE location is used as a basis to trigger the LMF network verification procedures using NTN adapted RAT-dependent positioning techniques, which is then described by the second embodiment. In another embodiment, a method to support NG-RAN location reporting and UE reported network verification for NTN multi-connectivity scenarios is described for three exemplary scenarios.

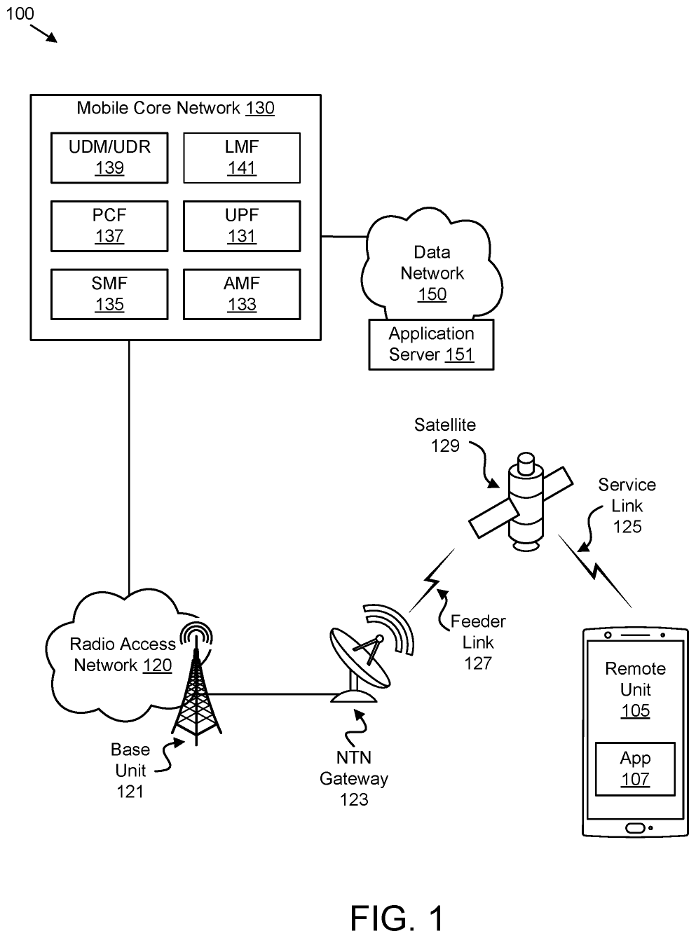

FIG. 1 depicts a wireless communication system 100 for NTN-based UE location verification, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates via a satellite 129 using wireless communication links, e.g., service link(s) 125 and feeder link(s) 127. As depicted, the mobile communication network includes an “on-ground” base unit 121 and non-terrestrial network (“NTN”) gateway 123 which serves the remote unit 105 via satellite access.

Even though a specific number of remote units 105, base units 121, wireless communication links, RANs 120, satellites 129, NTN gateways 123 (e.g., satellite ground/earth devices), and mobile core networks 140 are depicted in FIG. 1, one of skill in the art will recognize that any number of remote units 105, base units 121, wireless communication links, RANs 120, satellites 129, NTN gateways 123, and mobile core networks 140 may be included in the wireless communication system 100.

In one implementation, the RAN 120 is compliant with the 5G system specified in the Third Generation Partnership Project (“3GPP”) specifications. For example, the RAN 120 may be a NG-RAN, implementing NR RAT and/or 3GPP Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. In some embodiments, the remote units 105 communicate in a non-terrestrial network via UL and DL communication signals between the remote unit 105 and a satellite 129. In certain embodiments, the satellite 129 may communicate with the RAN 120 via an NTN gateway 123 using UL and DL communication signals between the satellite 129 and the NTN gateway 123. The NTN gateway 123 may communicate directly with the base units 121 in the RAN 120 to relay UL and DL communication signals.

Furthermore, the UL and DL communication signals may be carried over the wireless communication links during at least a portion of their path between RAN 120 and the remote unit 105. In the depicted embodiment, the wireless communication link between the remote unit 105 and satellite 129 comprises a service link 125, while the wireless communication link between the satellite 129 and the base unit 121 comprises a feeder link 127. However, in other embodiments, the satellite(s) and NTN gateways may be deployed between the base unit 121 or RAN 120 and the mobile core network 140, e.g., similar to wireless backhaul links.

The RAN 120 is an intermediate network that provides the remote units 105 with access to the mobile core network 140. In various embodiments, the UL communication signals may comprise one or more uplink channels, such as the Physical Uplink Control Channel (“PUCCH”) and/or Physical Uplink Shared Channel (“PUSCH”), while the DL communication signals may comprise one or more downlink channels, such as the Physical Downlink Control Channel (“PDCCH”) and/or Physical Downlink Shared Channel (“PDSCH”).

Moreover, the satellite 129 provides a non-terrestrial network allowing the remote unit 105 to access the mobile core network 140 via satellite access. While FIG. 1 depicts a transparent NTN system where the satellite 129 repeats the waveform signal for the base unit 121, in other embodiments the satellite 129 (for regenerative NTN system), or the NTN gateway 123 (for alternative implementation of transparent NTN system) may also act as base station, depending on the deployed configuration.

In some embodiments, the remote units 105 communicate with an application server via a network connection with the mobile core network 130. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 130 via the RAN 120. The mobile core network 130 then relays traffic between the remote unit 105 and the application server (e.g., the content server 151 in the packet data network 150) using the PDU session. The PDU session represents a logical connection between the remote unit 105 and the User Plane Function (“UPF”) 131.

To establish the PDU session (or PDN connection), the remote unit 105 must be registered with the mobile core network 130 (also referred to as “attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120. Note that in the NTN scenario, certain RAN entities or functions may be incorporated into the satellite 129. For example, the satellite 129 may be an embodiment of a Non-Terrestrial base station/base unit.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR-U operation, the base unit 121 and the remote unit 105 communicate over unlicensed radio spectrum.

In one embodiment, the mobile core network 130 is a 5GC or an Evolved Packet Core (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an AMF 133 that serves the RAN 120, a Session Management Function (“SMF”) 135, a Network Exposure Function (“NEF”), a Policy Control Function (“PCF”) 137, a Location Management Function (“LMF”) 141, a Unified Data Management function (“UDM”) and a User Data Repository (“UDR”) 139.

The UPF(s) 131 is responsible for packet routing and forwarding, packet inspection, QoS handling, and external PDU session for interconnecting Data Network (“DN”), in the 5G architecture. The AMF 133 is responsible for termination of NAS signaling, NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The NEF is responsible for making network data and resources easily accessible to customers and network partners. Service providers may activate new capabilities and expose them through APIs. These APIs allow third-party authorized applications to monitor and configure the network's behavior for a number of different subscribers (i.e., connected devices with different applications). The PCF 137 is responsible for unified policy framework, providing policy rules to CP functions, access subscription information for policy decisions in UDR.

The LMF 141, in one embodiment, receives positioning measurements or estimates from RAN 120 and the remote unit 105 (e.g., via the AMF 133) and computes the position of the remote unit 105. The UDM 139 is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

While FIG. 1 depicts components of a 5G RAN and a 5G core network, the described embodiments apply to other types of communication networks and RATs, including IEEE 802.11 variants, Global System for Mobile Communications (“GSM”, i.e., a 2G digital cellular network), General Packet Radio Service (“GPRS”), UMTS, LTE variants, CDMA 2000, Bluetooth, ZigBee, Sigfox, and the like.

In the following descriptions, the term “gNB” is used for the base station but it is replaceable by any other radio access node, e.g., RAN node, eNB, Base Station (“BS”), Access Point (“AP”), NR, etc. Further the operations are described mainly in the context of 5G NR. However, the proposed solutions/methods are also equally applicable to other mobile communication systems supporting CSI enhancements for higher frequencies.

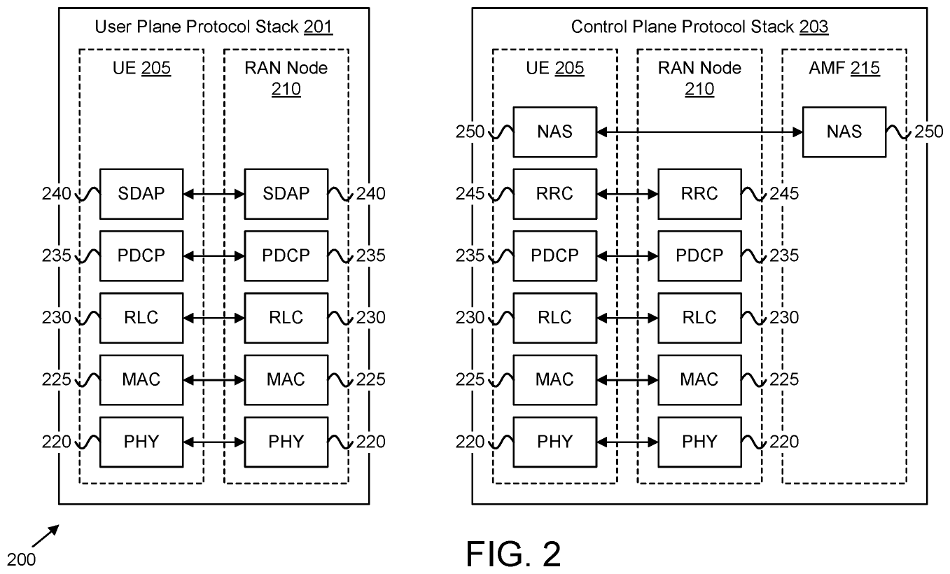

FIG. 2 depicts a NR protocol stack 200, according to embodiments of the disclosure. While FIG. 2 shows the UE 205, the RAN node 210 and an AMF 215 in a 5G core network (“5GC”), these are representative of a set of remote units 105 interacting with a base unit 121 and a mobile core network 140. As depicted, the protocol stack 200 comprises a User Plane protocol stack 201 and a Control Plane protocol stack 203. The User Plane protocol stack 201 includes a physical (“PHY”) layer 220, a Medium Access Control (“MAC”) sublayer 225, the Radio Link Control (“RLC”) sublayer 230, a Packet Data Convergence Protocol (“PDCP”) sublayer 235, and a Service Data Adaptation Protocol (“SDAP”) sublayer 240. The Control Plane protocol stack 203 includes a physical layer 220, a MAC sublayer 225, a RLC sublayer 230, and a PDCP sublayer 235. The Control Plane protocol stack 203 also includes a Radio Resource Control (“RRC”) sublayer 245 and a Non-Access Stratum (“NAS”) sublayer 250.

The AS layer (also referred to as “AS protocol stack”) for the User Plane protocol stack 201 consists of at least SDAP, PDCP, RLC and MAC sublayers, and the physical layer. The AS layer for the Control Plane protocol stack 203 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC sublayer 245 and the NAS layer 250 for the control plane and includes, e.g., an Internet Protocol (“IP”) layer and/or PDU Layer (not depicted) for the user plane. L1 and L2 are referred to as “lower layers,” while L3 and above (e.g., transport layer, application layer) are referred to as “higher layers” or “upper layers.”

The physical layer 220 offers transport channels to the MAC sublayer 225. The physical layer 220 may perform a Clear Channel Assessment and/or Listen-Before-Talk (“CCA/LBT”) procedure using energy detection thresholds, as described herein. In certain embodiments, the physical layer 220 may send a notification of UL Listen-Before-Talk (“LBT”) failure to a MAC entity at the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and the 5GC 215. NAS messages are passed transparently through the RAN. The NAS layer 250 is used to manage the establishment of communication sessions and for maintaining continuous communications with the UE 205 as it moves between different cells of the RAN. In contrast, the AS layer is between the UE 205 and the RAN (e.g., RAN node 210) and carries information over the wireless portion of the network.

As background, NR positioning based on NR Uu signals and standalone (“SA”) architecture (e.g., beam-based transmissions) was first specified in Rel-16. The target use cases also included commercial and regulatory (e.g., emergency services) scenarios as in Rel-15. The performance requirements are the following, e.g., described in TR 38.855:

| Positioning Error | Indoor | Outdoor |
|---|---|---|
| Horizontal Positioning | <3 m for 80% of UEs | <10 m for 80% of UEs |
| Vertical Positioning | <3 m for 80% of UEs | <3 m for 80% of UEs |

3GPP Rel-17 Positioning has recently defined the positioning performance requirements for Commercial and IIoT use cases as follows, e.g., as described in TR 38.857:

| Positioning Error | Commercial | IIoT |
|---|---|---|
| Horizontal Positioning | (<1 m) for 90% of UEs | (<0.2 m) for 90% of UEs; |
| Vertical Positioning | (<3 m) for 90% of UEs | (<1 m) for 90% of UEs |
| Physical layer latency for | (<10 ms) | (<10 ms) |
| position estimation of UE | | |
| End-to-End Latency for | (<100 ms) | (<100 ms, in the order of 10 |
| position estimation of UE | | ms is desired) |

Some UE positioning techniques supported in Rel-16 are listed in Table 1. The separate positioning techniques as indicated in Table 2 may be configured and performed based on the requirements of the LMF and/or UE capabilities. Note that Table 1 includes Terrestrial Beacon System (“TBS”) positioning based on PRS signals, but only observed time difference of arrival (“OTDOA”) based on LTE signals is supported. The E-CID includes Cell-ID for NR method. The TBS method refers to TBS positioning based on Metropolitan Beacon System (“MBS”) signals.

TABLE 1
Supported Rel-16 UE positioning methods

| | | UE-assisted, | NG-RAN node | Secure User Plane Location |
|---|---|---|---|---|
| Method | UE-based | LMF-based | assisted | (“SUPL”) |
| A-GNSS | Yes | Yes | No | Yes (UE-based and UE-assisted) |
| OTDOA | No | Yes | No | Yes (UE-assisted) |
| E-CID | No | Yes | Yes | Yes for E-UTRA (UE-assisted) |
| Sensor | Yes | Yes | No | No |
| WLAN | Yes | Yes | No | Yes |
| Bluetooth | No | Yes | No | No |
| TBS | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

The transmission of PRS enable the UE to perform UE positioning-related measurements to enable the computation of a UE's location estimate and are configured per Transmission Reception Point (“TRP”), where a TRP may transmit one or more beams.

In one embodiment, the following RAT-dependent positioning techniques may be supported by the system 100:

DL-TDoA: The downlink time difference of arrival (“DL-TDOA”) positioning method makes use of the DL RS Time Difference (“RSTD”) (and optionally DL PRS RS Received Power (“RSRP”) of DL PRS RS Received Quality (“RSRQ”)) of downlink signals received from multiple TPs, at the UE (e.g., remote unit 105). The UE measures the DL RSTD (and optionally DL PRS RSRP) of the received signals using assistance data received from the positioning server, and the resulting measurements are used along with other configuration information to locate the UE in relation to the neighboring Transmission Points (“TPs”).

DL-AoD: The DL Angle of Departure (“AoD”) positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

Multi-RTT: The Multiple-Round Trip Time (“Multi-RTT”) positioning method makes use of the UE Receive-Transmit (“Rx-Tx”) measurements and DL PRS RSRP of downlink signals received from multiple TRPs, measured by the UE and the gNB Rx-Tx measurements (e.g., measured by RAN node) and UL sounding reference signal (“SRS”)-RSRP at multiple TRPs of uplink signals transmitted from UE.

The UE measures the UE Rx-Tx measurements (and optionally DL PRS RSRP of the received signals) using assistance data received from the positioning server, and the TRPs measure the gNB Rx-Tx measurements (and optionally UL SRS-RSRP of the received signals) using assistance data received from the positioning server. The measurements are used to determine the Round Trip Time (“RTT”) at the positioning server which are used to estimate the location of the UE. In one embodiment, Multi-RTT is only supported for UE-assisted/NG-RAN assisted positioning techniques, as noted in Table 1.

E-CID/NR E-CID: Enhanced Cell ID (“CID”) positioning method, the position of a UE is estimated with the knowledge of its serving ng-eNB, gNB and cell and is based on LTE signals. The information about the serving ng-eNB, gNB and cell may be obtained by paging, registration, or other methods. NR Enhanced Cell ID (“NR E-CID”) positioning refers to techniques which use additional UE measurements and/or NR radio resource and other 20) measurements to improve the UE location estimate using NR signals.

Although NR E-CID positioning may utilize some of the same measurements as the measurement control system in the RRC protocol, the UE generally is not expected to make additional measurements for the sole purpose of positioning; e.g., the positioning procedures do not supply a measurement configuration or measurement control message, and the UE reports the measurements that it has available rather than being required to take additional measurement actions.

UL-TDoA: The UL TDOA positioning method makes use of the UL TDOA (and optionally UL SRS-RSRP) at multiple reception points (“RPs”) of uplink signals transmitted from the UE. The RPs measure the UL TDOA (and optionally UL SRS-RSRP) of the received signals using assistance data received from the positioning server, and the resulting measurements are used along with other configuration information to estimate the location of the UE.

UL-AoA: The UL Angle of Arrival (“AoA”) positioning method makes use of the measured azimuth and the zenith angles of arrival at multiple RPs of uplink signals transmitted from the UE. The RPs measure A-AoA and Z-AoA of the received signals using assistance data received from the positioning server, and the resulting measurements are used along with other configuration information to estimate the location of the UE.

In one embodiment, the system 100 may support various RAT-Independent techniques, e.g., as described in TS 38.305. In one embodiment, network-assisted global navigation satellite system (“GNSS”) methods make use of UEs that are equipped with radio receivers capable of receiving GNSS signals. In 3GPP specifications the term GNSS encompasses both global and regional/augmentation navigation satellite systems.

Examples of global navigation satellite systems include GPS, Modernized GPS, Galileo, GLONASS, and BeiDou Navigation Satellite System (“BDS”). Regional navigation satellite systems include Quasi Zenith Satellite System (“QZSS”) while the many augmentation systems, are classified under the generic term of Space Based Augmentation Systems (“SBAS”) and provide regional augmentation services. In this concept, different GNSSs (e.g. GPS, Galileo, etc.) can be used separately or in combination to determine the location of a UE.

In one embodiment, a barometric pressure sensor method makes use of barometric sensors to determine the vertical component of the position of the UE. The UE measures barometric pressure, optionally aided by assistance data, to calculate the vertical component of its location or to send measurements to the positioning server for position calculation. This method may be combined with other positioning methods to determine the 3D position of the UE.

In one embodiment, a WLAN positioning method makes use of the WLAN measurements (e.g., AP identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated. Alternatively, the UE makes use of WLAN measurements and optionally WLAN AP assistance data provided by the positioning server, to determine its location.

In one embodiment, a Bluetooth positioning method makes use of Bluetooth measurements (beacon identifiers and optionally other measurements) to determine the location of the UE. The UE measures received signals from Bluetooth beacons. Using the measurement results and a references database, the location of the UE is calculated. The Bluetooth methods may be combined with other positioning methods (e.g. WLAN) to improve positioning accuracy of the UE.

In one embodiment, a TBS consists of a network of ground-based transmitters, broadcasting signals only for positioning purposes. The current type of TBS positioning signals are the MBS signals and PRS. The UE measures received TBS signals, optionally aided by assistance data, to calculate its location or to send measurements to the positioning server for position calculation.

In one embodiment, a motion sensor method makes use of different sensors such as accelerometers, gyros, magnetometers, to calculate the displacement of UE. The UE estimates a relative displacement based upon a reference position and/or reference time. UE sends a report comprising the determined relative displacement which can be used to determine the absolute position. This method should be used with other positioning methods for hybrid positioning.

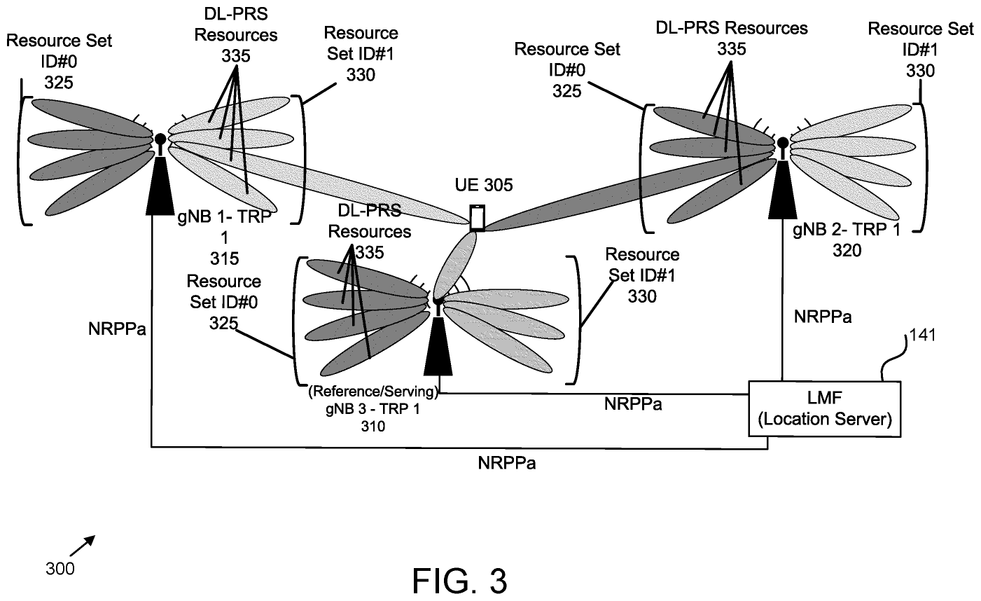

FIG. 3 depicts a system 300 for NR beam-based positioning. According to Rel-16, the PRS can be transmitted by different base stations (serving and neighboring) using narrow beams over Frequency Range #1 Between (“FR1”, e.g., frequencies from 410 MHz to 7125 MHz) and Frequency Range #2 (“FR2”, e.g., frequencies from 24.25 GHz to 52.6 GHz), which is relatively different when compared to LTE where the PRS was transmitted across the whole cell.

As illustrated in FIG. 3, a UE 305 may receive PRS from a first gNB (“gNB 3”) 310, which is a serving gNB, and also from a neighboring second gNB (“gNB 1”) 315, and a neighboring third gNB (“gNB 2”) 320. Here, the PRS can be locally associated with a set of PRS Resources grouped under a Resource Set ID for a base station (e.g., TRP). In the depicted embodiments, each gNB 310, 315, 320 is configured with a first Resource Set ID 325 and a second Resource Set ID 330. As depicted, the UE 305 receives PRS on transmission beams; here, receiving PRS from the gNB 3 310 on a set of PRS Resources 335 from the second Resource Set ID 330, receiving PRS from the gNB 1 315 on a set of PRS Resources 335 from the second Resource Set ID 330, and receiving PRS from the gNB 2 320 on a set of PRS Resources 335 from the first Resource Set ID 325.

Similarly, UE positioning measurements such as Reference Signal Time Difference (“RSTD”) and PRS RSRP measurements are made between beams as opposed to different cells as was the case in LTE. In addition, there are additional UL positioning methods for the network to exploit in order to compute the target UE's location. Table 2 and Table 3 show the reference signal to measurements mapping required for each of the supported RAT-dependent positioning techniques at the UE and gNB, respectively. RAT-dependent positioning techniques involve the 3GPP RAT and core network entities to perform the position estimation of the UE, which are differentiated from RAT-independent positioning techniques which rely on GNSS, IMU sensor, WLAN and Bluetooth technologies for performing target device (e.g., UE) positioning.

TABLE 2
UE Measurements to enable RAT-dependent positioning techniques

| DL/UL Reference | | To facilitate support of the |
|---|---|---|
| Signals | UE Measurements | following positioning techniques |
| Rel. 16 DL PRS | DL RSTD | DL-TDOA |
| Rel. 16 DL PRS | DL PRS RSRP | DL-TDOA, DL-AoD, Multi-RTT |
| Rel. 16 DL PRS / | UE Rx − Tx time difference | Multi-RTT |
| Rel. 16 SRS for | | |
| positioning | | |
| Rel. 15 SSB / CSI- | SS-RSRP(RSRP for RRM), SS- | E-CID |
| RS for RRM | RSRQ(for RRM), CSI-RSRP (for | |
| | RRM), CSI-RSRQ (for RRM), SS- | |
| | RSRPB (for RRM) | |

TABLE 3
gNB Measurements to enable RAT-
dependent positioning techniques

| | | To facilitate support |
|---|---|---|
| | gNB | of the following |
| DL/UL Reference Signals | Measurements | positioning techniques |
| Rel. 16 SRS for positioning | UL RTOA | UL-TDOA |
| Rel. 16 SRS for positioning | UL SRS-RSRP | UL-TDOA, UL-AoA, |
| | | Multi-RTT |
| Rel. 16 SRS for positioning, | gNB Rx − Tx | Multi-RTT |
| Rel. 16 DL PRS | time difference | |
| Rel. 16 SRS for positioning, | AoA and ZoA | UL-AoA, Multi-RTT |

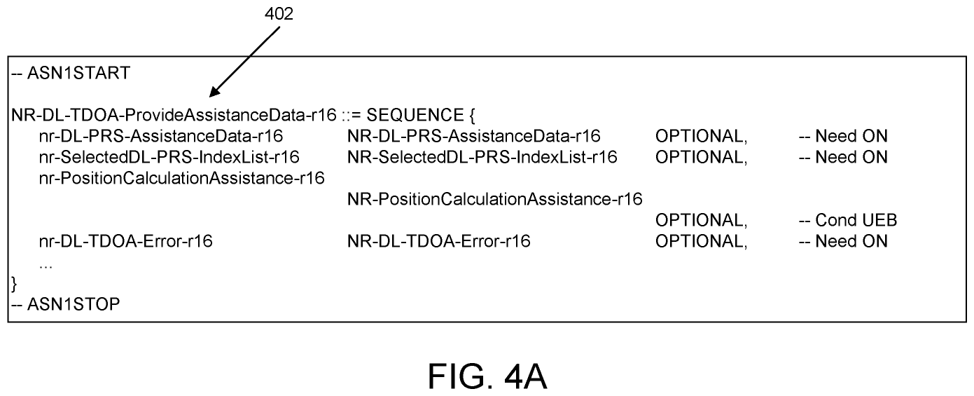

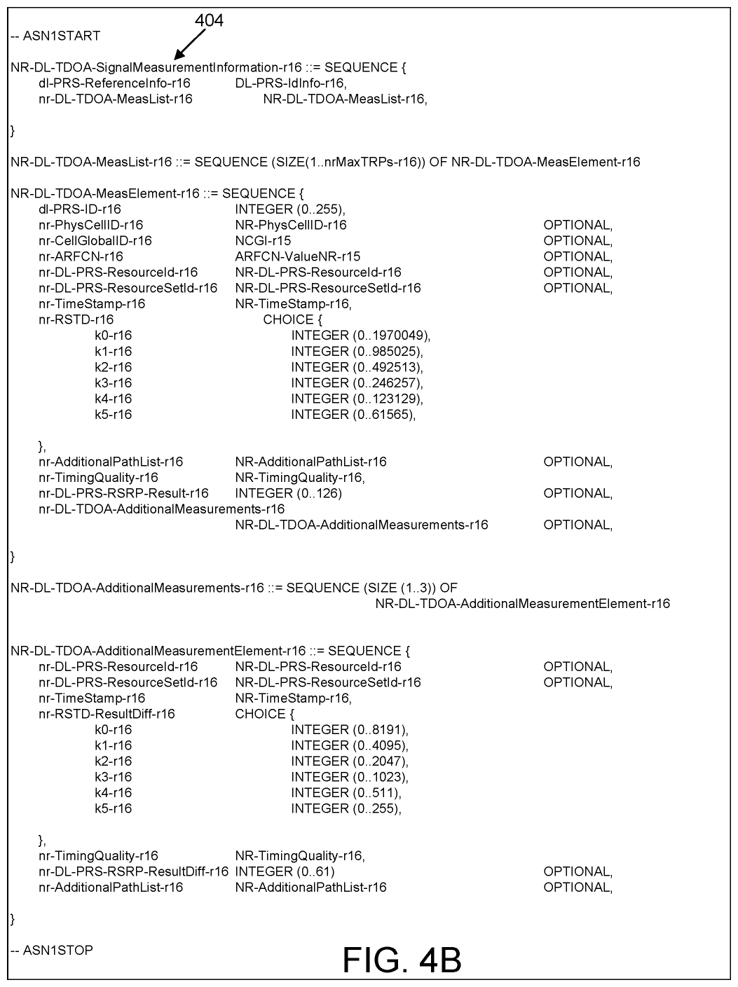

Regarding Measurement and Report Configuration, according to TS38.215, UE measurements have been defined, which are applicable to DL-based positioning techniques, see subclause 2.4. For a conceptual overview of the current implementation in Rel-16, the assistance data configurations (see FIG. 4A) and measurement information (see FIG. 4B) are provided for each of the supported positioning techniques:

The information element (“IE”) NR-DL-TDOA-Provide Assistance Data 402, shown in FIG. 4A, is used by the location server to provide assistance data to enable UE-assisted and UE-based NR downlink TDOA. It may also be used to provide NR DL TDOA positioning specific error reason.

The IE NR-DL-TDOA-SignalMeasurementInformation 404, shown in FIG. 4B, is used by the target device to provide NR-DL TDOA measurements to the location server. The measurements are provided as a list of TRPs, where the first TRP in the list is used as reference TRP in case RSTD measurements are reported. The first TRP in the list may or may not be the reference TRP indicated in the NR-DL-PRS-AssistanceData. Furthermore, the target device selects a reference resource per TRP, and compiles the measurements per TRP based on the selected reference resource.

Regarding RAT-dependent Positioning Measurements, the different DL measurements including DL PRS-RSRP, DL RSTD and UE Rx-Tx Time Difference required for the supported RAT-dependent positioning techniques are shown in Table 4. The following measurement configurations may be specified:
4 Pair of DL RSTD measurements can be performed per pair of cells. Each measurement is performed between a different pair of DL PRS Resources/Resource Sets with a single reference timing.
8 DL PRS RSRP measurements can be performed on different DL PRS resources from the same cell.

TABLE 4
DL Measurements required for DL-based positioning methods
DL PRS reference signal received power (DL PRS-RSRP)

| | |
|---|---|
| Definition | DL PRS reference signal received power (DL PRS-RSRP), is defined as the linear |
| | average over the power contributions (in [W]) of the resource elements that carry DL |
| | PRS reference signals configured for RSRP measurements within the considered |
| | measurement frequency bandwidth. |
| | For frequency range 1, the reference point for the DL PRS-RSRP shall be the antenna |
| | connector of the UE. For frequency range 2, DL PRS-RSRP shall be measured based |
| | on the combined signal from antenna elements corresponding to a given receiver |
| | branch. For frequency range 1 and 2, if receiver diversity is in use by the UE, the |
| | reported DL PRS-RSRP value shall not be lower than the corresponding DL PRS- |
| | RSRP of any of the individual receiver branches. |
| Applicable for | RRC_CONNECTED intra-frequency, |
| | RRC_CONNECTED inter-frequency |

DL reference signal time difference (DL RSTD)

| | |
|---|---|
| Definition | DL reference signal time difference (DL RSTD) is the DL relative timing difference |
| | between the positioning node j and the reference positioning node i, defined as |
| | T_{SubframeRxj} − T_{SubframeRxi}, |
| | Where: |
| | T_{SubframeRxj} is the time when the UE receives the start of one subframe from positioning |
| | node j. |
| | T_{SubframeRxi} is the time when the UE receives the corresponding start of one subframe |
| | from positioning node i that is closest in time to the subframe received from |
| | positioning node j. |
| | Multiple DL PRS resources can be used to determine the start of one subframe from a |
| | positioning node. |
| | For frequency range 1, the reference point for the DL RSTD shall be the antenna |
| | connector of the UE. For frequency range 2, the reference point for the DL RSTD shall |
| | be the antenna of the UE. |
| Applicable for | RRC_CONNECTED intra-frequency |
| | RRC_CONNECTED inter-frequency |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a positioning node, |
| | defined by the first detected path in time. |
| | T_{UE-TX} is the UE transmit timing of uplink subframe #j that is closest in time to the |
| | subframe #i received from the positioning node. |
| | Multiple DL PRS resources can be used to determine the start of one subframe of the |
| | first arrival path of the positioning node. |
| | For frequency range 1, the reference point for T_{UE-RX} measurement shall be the Rx |
| | antenna connector of the UE and the reference point for T_{UE-TX} measurement shall be |
| | the Tx antenna connector of the UE. For frequency range 2, the reference point for |
| | T_{UE-RX} measurement shall be the Rx antenna of the UE and the reference point for |
| | T_{UE-TX} measurement shall be the Tx antenna of the UE. |
| Applicable for | RRC_CONNECTED intra-frequency |
| | RRC_CONNECTED inter-frequency |

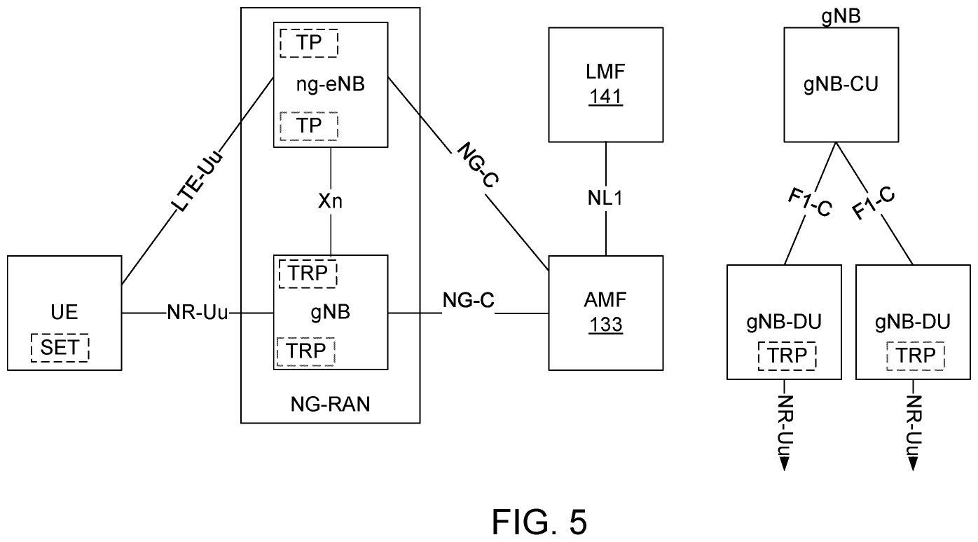

FIG. 5 shows the architecture in 5GS applicable to positioning of a UE with NR or E-UTRA access. In one embodiment, the AMF 133 receives a request for some location service associated with a particular target UE from another entity (e.g., Gateway Mobile Location Center (“GMLC”) or UE) or the AMF 133 itself decides to initiate some location service on behalf of a particular target UE (e.g., for an IP Multimedia System (“IMS”) emergency call from the UE), e.g., as described in TS 23.502 and TS 23.273. The AMF 133 then sends a location services request to an LMF 141. The LMF 141 processes the location services request which may include transferring assistance data to the target UE to assist with UE-based and/or UE-assisted positioning and/or may include positioning of the target UE. The LMF 141 then returns the result of the location service back to the AMF 133 (e.g., a position estimate for the UE). In the case of a location service requested by an entity other than the AMF 133 (e.g., a GMLC or UE), the AMF 133 returns the location service result to this entity.

In one embodiment, an NG-RAN node may control several TRPs/TPs, such as remote radio heads, or DL-PRS-only TPs for support of PRS-based TBS. In one embodiment, an LMF 141 may have a proprietary signaling connection to an E-Serving Mobile Location Center (“SMLC”) which may enable an LMF 141 to access information from E-UTRAN (e.g., to support the OTDOA for E-UTRA positioning method using downlink measurements obtained by a target UE of signals from eNBs and/or PRS-only TPs in E-UTRAN). An LMF 141 may have a proprietary signaling connection to an SLP. The SLP is the SUPL entity responsible for positioning over the user plane. Further details of user-plane positioning are provided in TS38.305 Annex A.

In case of split gNB architecture, a gNB-DU may include TRP functionality where the TRP functionality may support functions for a TP, RP or both TP and RP. A gNB-DU which includes TRP functionality does not need to offer cell services.

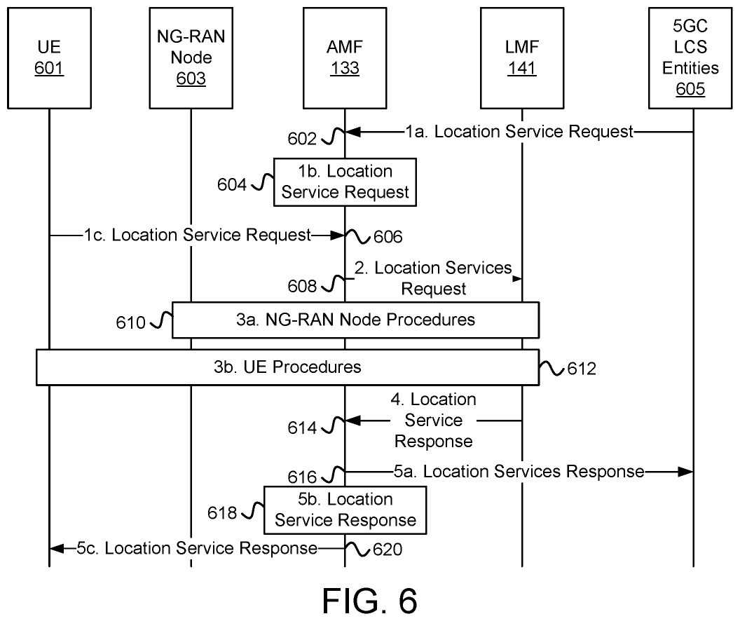

Regarding RAN-UE positioning operations, to support positioning of a target UE and delivery of location assistance data to a UE with NG-RAN access in 5GS, location related functions are distributed as shown in the architecture in FIG. 5 and as clarified in greater detail in TS 23.501 and TS 23.273. The overall sequence of events applicable to the UE, NG-RAN and LMF for any location service is shown in FIG. 6.

Note that when the AMF receives a Location Service Request in case the UE is in CM-IDLE state, the AMF performs a network triggered service request, e.g., as defined in TS 23.502 and TS 23.273, to establish a signaling connection with the UE and assign a specific serving gNB or NG-eNB. The UE is assumed to be in connected mode before the beginning of the flow shown in the FIG. 6; that is, any signaling that might be required to bring the UE to connected mode prior to step 1a is not shown. The signaling connection may, however, be later released (e.g., by the NG-RAN node as a result of signaling and data inactivity) while positioning is still ongoing.

The procedure flow depicted in FIG. 6, in one embodiment, includes a UE 601, an NG-RAN Node 603, an AMF 133, an LMF 141, and 5GC location services (“LCS”) Entities 605.

At step 1a, an entity in the 5GC (e.g., GMLC) requests (see messaging 602) a location service (e.g., positioning) for a target UE 601 to the serving AMF 133. At step 1b, the serving AMF 133 for a target UE 601 determines (see block 604) the need for some location service (e.g., to locate the UE 601 for an emergency call). At step 1c, the UE 601 requests (see messaging 606) some location service (e.g., positioning or delivery of assistance data) to the serving AMF 133 at the NAS level.

In one embodiment, at step 2, the AMF 133 transfers (see messaging 608) the location service request to an LMF 141. At step 3a, the LMF 141 instigates (see block 610) location procedures with the serving and possibly neighboring ng-eNB or gNB in the NG-RAN 603—e.g., to obtain positioning measurements or assistance data. In one embodiment, in addition to step 3a or instead of step 3a, at step 3b, the LMF 141 instigates (see block 612) location procedures with the UE 601—e.g., to obtain a location estimate or positioning measurements or to transfer location assistance data to the UE 601.

In one embodiment, at step 4, the LMF 141 provides (see messaging 614) a location service response to the AMF 133 and includes any needed results—e.g., success or failure indication and, if requested and obtained, a location estimate for the UE 601. In one embodiment, at step 5a, if step 1a was performed, the AMF 133 returns (see messaging 616) a location service response to the 5GC entity 605 in step 1a and includes any needed results—e.g., a location estimate for the UE 601. In one embodiment, at step 5b, if step 1b occurred, the AMF 133 uses (see block 618) the location service response received in step 4 to assist the service that triggered this in step 1b (e.g., may provide a location estimate associated with an emergency call to a GMLC). At step 5c, in one embodiment, if step 1c was performed, the AMF 133 returns a location service response to the UE 601 and includes any needed results—e.g., a location estimate for the UE 601.

Location procedures applicable to NG-RAN, in one embodiment, occur in steps 3a and 3b in FIG. 6. Other steps in FIG. 6 are applicable to the 5GC and are described in greater detail in TS 23.502 and TS 23.273. In one embodiment, steps 3a and 3b involve the use of different positioning methods to obtain location related measurements for a target UE and from these computes a location estimate and possibly additional information like velocity.

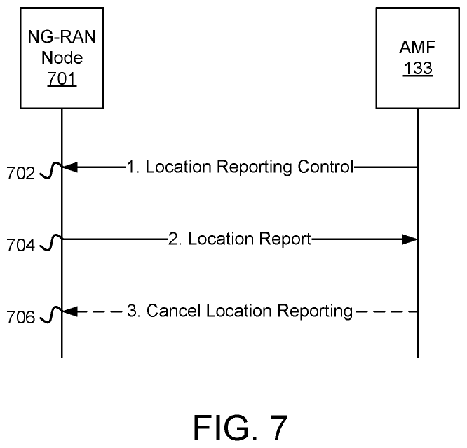

FIG. 7 depicts a procedure flow for NG-RAN location reporting procedures, e.g., as described in TS 23.502. In one embodiment, the depicted procedure is used by an AMF 133 to request the NG-RAN 701 to report where the UE is currently located when the target UE is in CM-CONNECTED state. The need for the NG-RAN 701 to continue reporting ceases when the UE transitions to CM-IDLE or the AMF 133 sends cancel indication to NG-RAN 701. This procedure may be used for services that require accurate cell identification (e.g., emergency services, lawful intercept, charging), or for subscription to the service by other NFs. When Dual Connectivity is activated, PSCell information is only reported if requested by the AMF 133.

At step 1, in one embodiment, the AMF 133 sends (see messaging 702) a Location Reporting Control message to the NG-RAN 701. The Location Reporting Control message shall identify the UE for which reports are requested and shall include Reporting Type and Location Reporting Level. The Location Reporting Control message may also include Area of Interest and Request Reference ID. Location Reporting Level could be TAI+ Cell Identity. Reporting Type indicates whether the message is intended to trigger a single standalone report about the current Cell Identity serving the UE or start the NG-RAN 701 to report whenever the UE changes cell or ask the NG-RAN 701 to report whenever the UE moves out or into the Area of Interest. If the Reporting Type indicates to report whenever the UE changes cell and if PScell reporting is requested and Dual Connectivity is in use, the Master RAN node shall also report to the AMF 133 whenever the PSCell changes. If the Reporting Type indicates to start the NG-RAN 701 to report when UE moves out of or into the Area of Interest, the AMF 133 also provides the requested Area of Interest information in the Location Reporting Control message. The AMF 133 may include a Request Reference ID in the Location Report Control message to identify the request of reporting for an Area of Interest. If multiple Areas of Interest are included in the message, the Request Reference ID identifies each Area of Interest.

It is noted that requesting reports whenever the UE changes cell can increase signaling load on multiple interfaces. Requesting reports for all changes in PSCell ID can further increase signaling load. Hence it is recommended that any such reporting is only applied for a limited number of subscribers.

At step 2, in one embodiment, the NG-RAN 701 sends (see messaging 704) a Location Report message informing the AMF 133 about the location of the UE which shall be represented as the requested Location Reporting Level. If PSCell reporting is requested and Dual Connectivity is activated, then the Master NG-RAN node shall also include the PSCell ID. With NR satellite access, cell and TAI reporting by NG-RAN refer to a fixed cell and fixed TA in which a UE is geographically located. As part of the User Location Information, NG_RAN also reports one or more tracking area codes (“TACs”) for the Selected PLMN, e.g., as described in TS 38.413, but it is not guaranteed that the UE is always located in one of these TACs.

When the UE is in CM-CONNECTED with RRC Inactive state, if NG-RAN 701 has received Location Reporting Control message from AMF 133 with the Reporting Type indicating single stand-alone report, the NG-RAN 701 shall perform NG-RAN paging before reporting the location to the AMF 133. The NG-RAN 701 should send the Location Report promptly and shall not wait to attempt to create a Dual Connectivity configuration. However, if PSCell reporting is requested and the PSCell ID is known to the Master RAN node, then it shall be included in the Location Report. In the case of RAN paging failure, the RAN reports UE's last known location with time stamp.

When the UE is in CM-CONNECTED with RRC Inactive state, if NG-RAN 701 has received Location Reporting Control message from AMF 133 with the Reporting Type indicating continuous reporting whenever the UE changes cell, the NG-RAN 701 shall send a Location Report message to the AMF 133 including the UE's last known location with time stamp. If the UE was using Dual Connectivity immediately before entering CM-CONNECTED with RRC Inactive state and PSCell reporting is requested, then the Location Report shall also include the PSCell ID.

When the UE is in CM-CONNECTED, if NG-RAN 701 has received Location Reporting Control message from AMF 133 with the Reporting Type of Area of Interest based reporting, the NG-RAN 701 shall track the UE presence in Area of Interest and send a Location Report message to AMF 133 including the UE Presence in the Area of Interest (e.g., IN, OUT, or UNKNOWN) as described in clause D.2 and the UE's current location (including the PSCell ID if PSCell reporting is requested and Dual Connectivity is activated) when the UE is in RRC Connected state, or, when the UE is in RRC Inactive state, the UE's last known location (including the PSCell ID if PSCell reporting is requested and the UE was using Dual Connectivity immediately before entering CM-CONNECTED with RRC Inactive state) with time stamp if the NG-RAN 701 perceives that the UE presence in the Area of Interest is different from the last one reported. When the NG-RAN 701 detects that the UE has moved out of or into multiple areas of interest, it sends multiple pairs of UE Presence in the Area of Interest and the Request Reference ID in one Location Report message to AMF 133. If UE transitions from RRC Inactive state to RRC Connected state, NG-RAN 701 shall check the latest location (including the PSCell ID if PSCell reporting is requested and Dual Connectivity is activated) of UE and follow the rules when UE is in RRC Connected.

The AMF 133 may receive Location Report even if the UE presence in Area of Interest is not changed. The AMF 133 stores the latest received PSCell ID with its associated timestamp. The AMF 133 stores the latest received PSCell ID with its associated timestamp, when available.

In one embodiment, at step 3, the AMF 133 can send a Cancel Location Reporting message to inform the NG-RAN 701 that it should terminate the location reporting for a given UE corresponding to the Reporting Type or the location reporting for Area of Interest indicated by Request Reference ID. This message is needed when the reporting type was requested for continuously reporting or for the Area of Interest. The AMF 133 may include the Request Reference ID which indicates the requested Location Reporting Control for the Area of Interest, so that the NG-RAN 701 should terminate the location reporting for the Area of Interest. It is noted that location reporting related information of the source NG-RAN node is transferred to the target NG-RAN node during Xn handover.

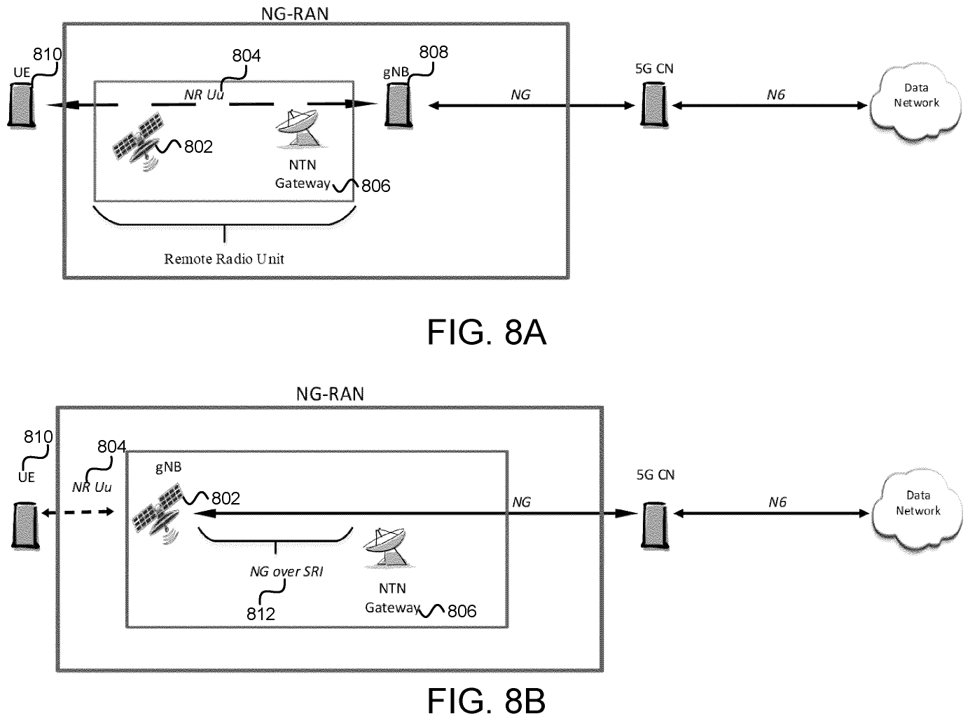

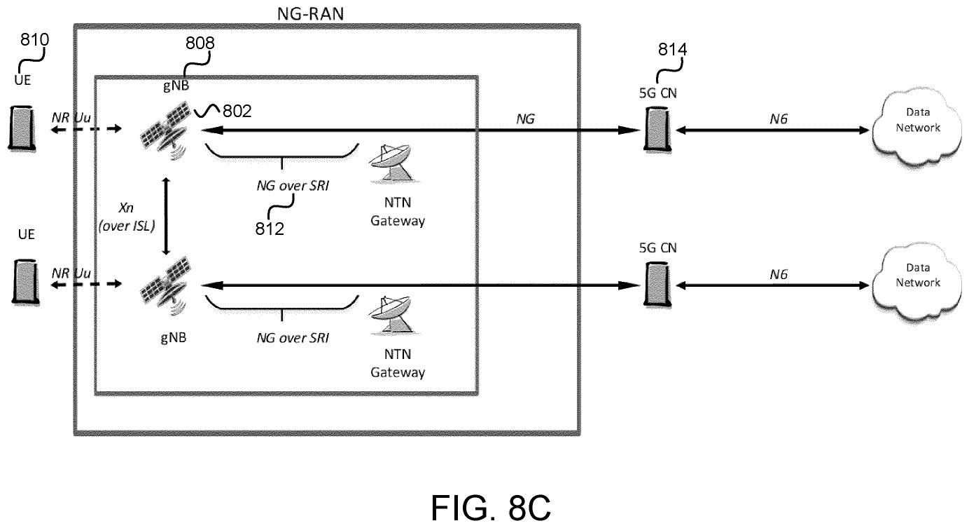

FIG. 8A depicts one embodiment of a transparent satellite-based NG-RAN architecture. In the depicted embodiment, the satellite payload implements frequency conversion and a Radio Frequency amplifier in both up link and down link direction. It corresponds to an analogue RF repeater. Hence the satellite 802 repeats the NR-Uu 804 radio interface from the feeder link (between the NTN gateway 806 and the satellite 802) to the service link (between the satellite 802 and the UE 810) and vice versa. The Satellite Radio Interface (“SRI”) on the feeder link is the NR-Uu 804. In other words, the satellite does not terminate NR-Uu 804. The NTN GW 806 supports all necessary functions to forward the signal of NR-Uu 804 interface. Different transparent satellites may be connected to the same gNB 808 on the ground. It is noted that while several gNBs 808 may access a single satellite payload, the description has been simplified to a unique gNB 808 accessing the satellite payload, without loss of generality.

FIG. 8B depicts one embodiment of a regenerative satellite-based NG-RAN architectures without ISL. In one embodiment, the NG-RAN logical architecture as described in TS 38.401 is used as baseline for NTN scenarios. The satellite payload implements regeneration of the signals received from Earth. The NR-Uu 804 radio interface is the service link between the UE 810 and the satellite 802 and the SRI 812 on the feeder link between the NTN gateway 806 and the satellite 802. SRI 812 is a transport link between NTN GW 806 and satellite 802. It is noted that the satellite 802 may embark additional traffic routing functions that are out of RAN scope. The satellite payload also provides ISL between satellites. ISL is a transport link between satellites. ISL may be a radio interface or an optical interface that may be 3GPP or non 3GPP defined but this is out of the study item scope. The NTN GW 806 is a Transport Network Layer node and supports all necessary transport protocol.

FIG. 8C depicts one embodiment of a regenerative satellite-based NG-RAN architectures with ISL. FIG. 8C illustrates that a UE 810 served by a gNB 808 on board a satellite 802 could access the 5GCN 814 via ISL. The gNB 808 on board different satellites 802 may be connected to the same 5GCN 814 on the ground. If the satellite 802 hosts more than one gNB 808, the same SRI 812 will transport all the corresponding NG interface instances.

In general, the subject matter disclosed herein provides solution enhancements for enabling network verified location of the target-UE. In one embodiment, a method is disclosed to enable NG-RAN location request and reporting triggered by the AMF for verification of the UE's location in an NTN deployment. In one embodiment, a method is disclosed to trigger the LMF to initiate network verification location procedures using NTN RAT-dependent positioning techniques. In one embodiment, a method is disclosed to support NG-RAN location reporting and UE reported network verification for NTN multi-connectivity scenarios. In one embodiment, the various embodiments described below may be implemented in combination with each other to support NR positioning using the supported NTN interfaces and network entities/nodes.

In one embodiment, for the purposes of this disclosure, a positioning-related reference signal may refer to a reference signal used for positioning procedures/purposes to estimate a target-UE's location, e.g., PRS, or based on existing reference signals such as SRS. A target-UE may be referred to as the device/entity to be localized/positioned. In one embodiment, a target-UE is referred to as the UE of interest in which the position is to be calculated by the network or the target-UE itself. Furthermore, subject matter disclosed in Lenovo Patent Application SMM020220104-GR-NP (IDF-153116) are incorporated herein by reference and may be implemented in combination with the embodiments in this disclosure.

In a first embodiment, a system is disclosed for RAT-independent location collection procedures between the AMF and UE (via the NG-RAN node). According to the first embodiment, a location request is initiated by the AMF to request an NG-RAN node to provide location information relating to the target-UE's current location in CM-CONNECTED state (comprising of either RRC_CONNECTED and RRC_INACTIVE state), where the location information consists of at least location information derived from RAT-independent methods (non-3GPP positioning methods). The current operation of requesting location information or network verification based on cell identity may not be valid/accurate in NTN deployments for the applicable services as the cell size is very large (e.g., in the order of hundreds of km) and may cover multiple areas of interest, e.g., one cell may span a whole continent in case of geo-satellites. In one embodiment, the main goal of the procedure is to obtain initial location information of the target-UE, which may be used register the UE in a particular PLMN/RAN Area and thereafter verified to utilize services such as emergency services, lawful intercept, charging, and subscription services in non-terrestrial networks.

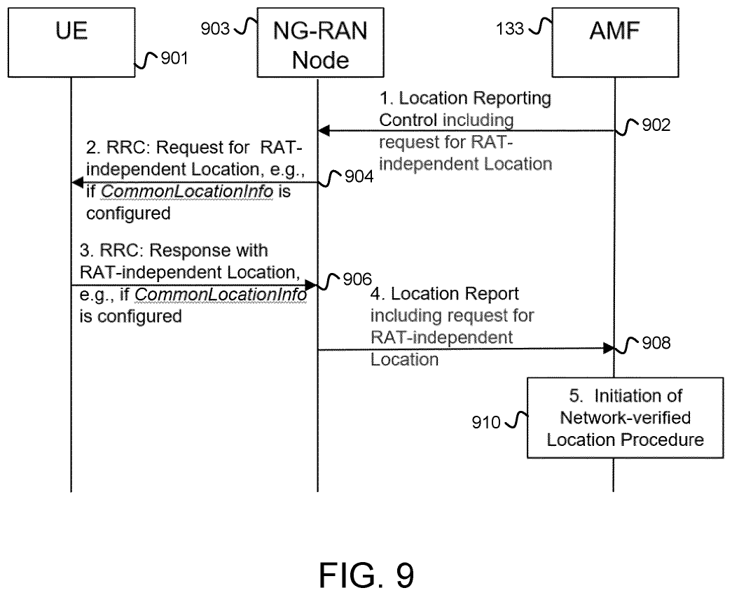

FIG. 9 depicts one embodiment of a procedure for NTN NG-RAN RAT-independent location reporting. In one embodiment, at step 1, a location reporting control message (see messaging 902) is initiated by the AMF 133 and includes a request for RAT-independent location information that includes GNSS information, e.g., GNSS time-of-day in ms (“ToD”) (e.g., based on GPS, GLONASS, NavIC), Bluetooth positioning, WLAN positioning, IMU sensor information, altitude, direction/orientation velocity estimates, accuracy, or combination thereof.

In one embodiment, at step 2, the NG-RAN node 903, e.g., a serving gNB, requests (see messaging 904) RAT-independent location information from the target-UE 901, e.g., using RRC signaling such as intra/inter-RAT measurement report, RRC reconfiguration, or the like provided that the CommonLocationInfo IE is configured. In this case, the trigger for the NG-RAN node 903 is derived from the request of the RAT-independent target-UE location information by the AMF 133.

In one embodiment, at step 3, the target-UE responds (see messaging 906) with the RAT-independent location information contained within the CommonlocationInfo IE. In one embodiment, at step 4, the NG-RAN node sends (see messaging 908) a location report response message including the RAT-independent location information to the AMF 133. In one embodiment, at step 5, the AMF 133 performs (see block 910) initiation of network-verified location procedures.

In an extended implementation of step 1 of FIG. 9, the AMF 133 initiates the location reporting control message to the NG-RAN 903, which may include an identifier for the UE 901 for which the report is requested. Moreover, in one embodiment, the following information may be requested in the configuration:
A location method type or location source may be indicated including RAT-dependent methods based on SL measurements, RAT Independent methods (e.g., GNSS) and Cell ID, SSB ID, beam ID, SSB measurements (e.g., RSRP) or CSI-RS measurements (e.g., RSRP);
The type of location reporting including single, periodic, event-based, and/or aperiodic reporting. In one embodiment, a single report may be requested and in other implementations a periodic report may be requested together with a configured periodicity or reporting interval and/or several reports. In the case of event-based reporting, the NG-RAN performs location reporting of the UE in the event that the area of the UE has changed, e.g., moving from one NTN cell/beam to another, or when moving from an NTN to a TN cell (or vice versa), or in the case of timer initiation/expiry;
A time stamp with the overall location report (e.g., location time stamp and NG-RAN time stamp) or, in the case that the report contains multiple locations, a timestamp associated with each location;
The configuration may also include a quality of measurement indicator/location estimate quality indicator associated with each location estimate, e.g., horizontal/vertical accuracy; and/or
UE mobility parameters including velocity estimates, acceleration estimates, and/or trajectory.

In the case of the transparent payload NTN architecture, the AMF, NG-RAN node, and UE may implement the procedures as depicted in FIG. 9. In the case of the regenerative payload NTN architecture, the AMF may transmit the location reporting control message to multiple NTN-gNB satellites in advance based on the movement of the different satellites as well as which satellite is in coverage of the target-UE at a given time. In another implementation, an event could be defined such that the location reporting control message is transmitted to the AMF according to each NTN-gNB handover.

In one embodiment, steps 2 and 3 of FIG. 9 may assist the NG-RAN node in determining the target-UE's location and may be a form of NG-RAN assistance information.

In an extended implementation of step 4 of FIG. 9, the NG-RAN node responds with a location report message to the AMF with the requested information contained in the configuration message of step 1 of FIG. 9, regarding the target-UE location information. The location information may be based on the location method type as indicated in the location reporting control message, e.g., GNSS based location information, cell/beam ID information, and/or the like, as well as the following additional elements:
Single/multiple Location points with single/multiple time stamps;
An error message indicating the non-availability of the requested location information, e.g., no UE location; and/or
A change in Cell/SSB ID due to satellite mobility and/or UE mobility, including previous NTN Cell ID/Beam ID and current NTN Cell ID/Beam ID.

In the case of regenerative payload NTN architecture, the source NTN-gNB may transfer the location report to the target NTN-gNB via an ISL for transfer to the AMF. In an alternative implementation, during an NTN-gNB handover, the AMF may receive an error message from the source NTN-gNB (e.g., NG-RAN node) or a handover indication prompting the AMF to re-trigger the location reporting control message with the target NTN-gNB.

In another extended implementation, the AMF may transmit a Cancel Location Reporting message, requesting the NG-RAN node to abort/stop any previously requested location reporting.

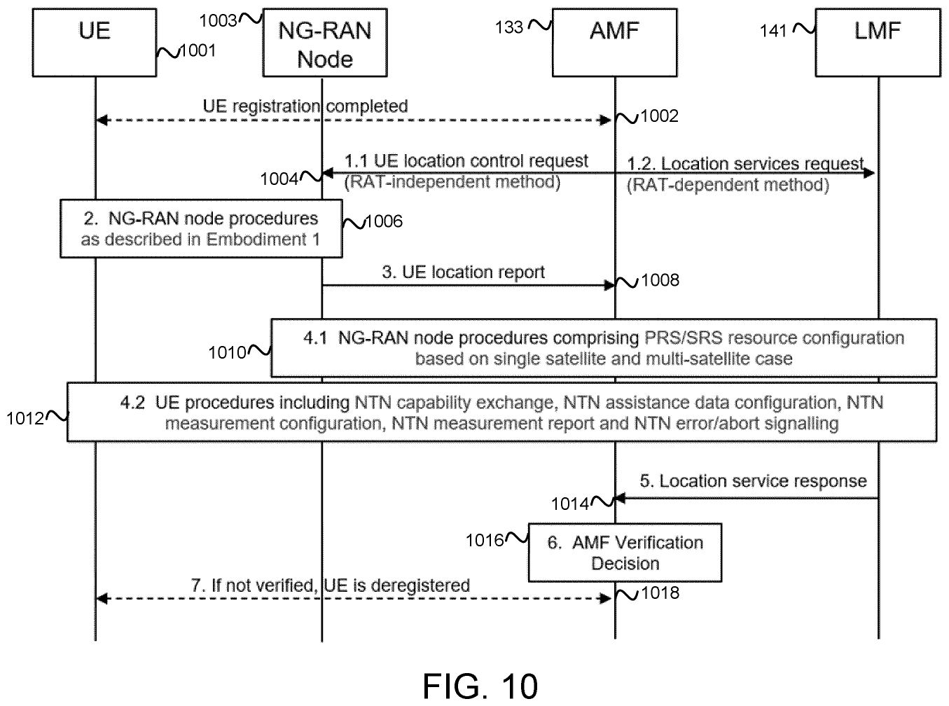

In an alternative implementation, where the NG-RAN node reports an error message about the UE reported location, the AMF may trigger the network-initiated location request procedures with the LMF, to directly determine the target-UE's position using RAT-independent or RAT-dependent methods or a combination thereof, which are further described below with reference to FIG. 10.

FIG. 10 depicts an AMF-initiated location reporting and verification procedure. In a second embodiment, after the UE registration is complete, the AMF initiates a location request procedure to verify the UE location in an NTN cell where the first reported location may be based on RAT-independent methods (e.g., GNSS) or Cell ID, as described in Embodiment 1, while a separate RAT-dependent based location procedure may be used to verify the UE reported location. The AMF may trigger a network-initiated location request for the purposes of performing location verification of the UE-reported location.

In one implementation, the AMF that initiates the location reporting and verification procedure, may be the serving AMF (e.g., based on a single PLMN) to NTN NG-RAN node. In an alternative implementation, any AMF may initiate the location reporting and verification procedure.

In one embodiment, the AMF initiates an NG-RAN based location request procedure while at the same time also initiates a network-initiated location service request to the serving LMF to initiate network-based location procedures to determine the target-UE's location (See FIG. 10). In one embodiment, it may be beneficial to initiate the network-based location procedures as early as possible due to the extended propagation delays of NTN systems. The network-based location procedures may comprise of RAT-dependent positioning methods using any one or more of the following positioning techniques:
DL-TDoA
DL-AOD
Multi-RTT
E-CID/NR E-CID
UL-TDoA
UL-AoA
SL-TDoA
SL-AoA/AOD
SL-RTT (one way and/or two way)
SL RSS measurement
Direct AI/ML positioning
AI/ML-assisted positioning techniques

In one embodiment, the aforementioned positioning techniques have also been adapted to the NTN scenario to account for the doppler compensation as well as the propagation delays experienced by the NTN system. The network-based verified UE position estimate may be derived based on PRS/SRS transmissions using an NTN network deployment and may be DL-based or UL-based or both DL-based and UL-based or SL-based measurements or combination thereof.

In one embodiment, the NG-RAN-based location request may provide a GNSS-based location or a Cell ID or an SSB ID or a beam ID. In one embodiment, both procedures are initiated in parallel, as shown in FIG. 10. FIG. 10 is an exemplary illustration of the call flows required to execute a verification of one or more UE location(s) retrieved from NG-RAN and stored in the AMF.

In another implementation, the AMF initiates these two location procedures in sequential order, e.g., once the NG-RAN reports back the location report, the AMF initiates the network-initiated location service request to the LMF.

As shown in FIG. 10, in one embodiment, after UE registration is completed (see procedure 1002), at step 1.1, the AMF 133 triggers the location request for location information to the NTN NG-RAN node 1003 (see messaging 1004) upon UE registration as described in Embodiment 1. In one embodiment, at step 1.2, the AMF 133 may also initiate a network (induced) location request with the LMF 141.

In one implementation, the NTN-verified location request may be transmitted by invoking the Nlmf_Location_DetermineLocation service operation towards the LMF 141 to request the current location of the UE 1001. In one embodiment, this service operation may comprise at least one of the following: an LCS Correlation identifier, the serving cell identity of the Primary NTN Cell in the Master RAN node, and the Primary NTN Cell in the Secondary RAN node, when available, based on Dual Connectivity scenarios, and an indication of the type of location request, e.g., a regulatory services client (e.g., emergency services). In one embodiment, the service operation may include an indication of whether the UE 1001 supports LTE positioning protocol (“LPP”), the required QoS (e.g., for emergency and regulatory services) and supported geographical area description (“GAD”) shapes, and the UE NTN Positioning Capabilities based on a prior signaling exchange with the LMF 141.

In another implementation, the AMF 133 may store the UE's 1001 positioning capabilities. In yet another implementation, the AMF 133 may indicate the use of RAT-dependent methods for UE location estimation as part of the verification procedure. These methods can be indicated based on the suitability for single satellite and multiple satellite scenarios. In a further indication, the AMF 133 may also indicate to the LMF 141 if the NTN deployment is a single or multi-satellite case. This location request trigger may be applicable for the following scenarios (NOTE: This step may be performed in parallel with step 1.1 or after step 3 depending on the scenario):
The AMF 133 performs verification of the UE location in terms of a configurable location granularity, e.g., based on a certain location accuracy (in the order of centimeters, meters, kilometers, or the like), country, or international area;
The UE 1001 registers to the 5GC for emergency services; and/or
The UE 1001 requests the establishment of a PDU Session related to an applicable regulatory service (e.g., emergency session initiation) or via an LCS service for a UE 1001 registering or is registered for NTN single or multi-satellite access.

In one embodiment, at step 2, for the above triggers, the NG-RAN 1003 initiates a procedure (see block 1006) to the UE based on the location type requested by AMF 133 (e.g., as detailed above with reference to Embodiment 1).

In one embodiment, at step 3, the NG-RAN 1003 provides (see messaging 1008) a UE location report to the AMF 133 based on the information received by UE 1001 (e.g., as detailed above with reference to Embodiment 1).

In one embodiment, the LMF 141 initiates the RAT-dependent location procedures with the NTN NG-RAN nodes 1003 and the UE 1001. At step 4.1, in one embodiment, the LMF 141 instigates location procedures with the serving and possibly neighboring NTN gNBs in the NG-RAN 1003 (see block 1010), which may be applicable to both the transparent and regenerative payload architectures, e.g., to perform PRS/SRS resource requests, to obtain positioning measurements, or the like, where the location procedures are RAT-dependent. This can also be applicable for the single and multi-satellite case. Examples may include the use of network-based positioning methods that rely on the NR positioning protocol A (“NRPPa”) protocol such as to exchange NTN gNB measurements, or the like.

In one embodiment, at step 4.2, the LMF 141 instigates location procedures, e.g., via LPP with the UE 1001 (see block 1012), e.g., to exchange NTN capability information, provide NTN assistance data configuration, to provide NTN location measurement configurations, to provide NTN location information reports (including location estimate or positioning measurements), to provide error/abort messages, and/or the like. In one embodiment, the modes of location estimation may include UE-assisted based positioning procedures, although in other implementations UE-based positioning procedures to determine the UE's 1001 location are not precluded.

At step 5, in one embodiment, the LMF 141 provides (see messaging 1014) a location service response to the AMF 133 and includes any needed results, e.g., location estimates for the UE 1001. This implementation may make use of the Nlmf_Location_DetermineLocation response to signal the location response to the AMF 133. The message may also contain service operations including the LCS Correlation identifier, the location estimates and its associated validity and accuracy, information about the positioning method including DL-based or UL-based or both DL-based and UL-based or SL-based measurements or a combination thereof, and the timestamp of the location estimate. The aforementioned contents may be mapped to one or more location estimates, each providing the described information. In the case of country determination, for instance, the service operation from the LMF 141 may also return an indication of the country or international area determined at step 4, in addition to the location estimate.

At step 6, in one embodiment, the AMF 133 verifies (see block 1016) the reported locations with the set criteria. The set criteria may include the time validity of the location estimate with respect to the received location from the NG-RAN 1003, the area validity relating to the areas in which both the RAT-independent and RAT-dependent location estimates were computed, and/or the like. If successful, in one embodiment, no further steps are necessary. In the case that steps 1.1-3 are not supported, in one embodiment, e.g., the UE 1001 does not have RAT-25 independent positioning capabilities, step 1.2 may be initiated and thereafter continue from step 4.1 onwards.

In one embodiment, at step 7, if it is determined (see procedure 1018) that the UE location verification is successful, the UE 1001 continues to maintain its connection with the network; otherwise, if the UE location verification fails, the UE 1001 is deregistered from the network.

Once the position of the provided RAT-independent method has been verified, in one embodiment, the network (e.g., the AMF 133 and the LMF 141) may assign a location certificate indicating that the reported location of the UE 1001 via NG-RAN 1003 may be trusted for a period of time, which may include minutes, hours, days, or an absolute time base and date. In one embodiment, this avoids repeated and unnecessary network verification signaling on the network side. For example, if the UE-reported location to be verified was GNSS and is then successfully verified using RAT-dependent methods, the network may issue a location certificate certifying the authenticity of the UE's reported GNSS position for a period of time, where upon expiry of the location certificate the AMF re-triggers the network verification procedure. In one embodiment, this can enable low latency NTN position fixes for, e.g., emergency services.

In a third embodiment, directed to location reporting and verification using different multi-connectivity options, the solutions on NG-RAN reporting and location verification of the target-UE using dual connectivity between multiple satellites and TN and NTN connectivity are described.

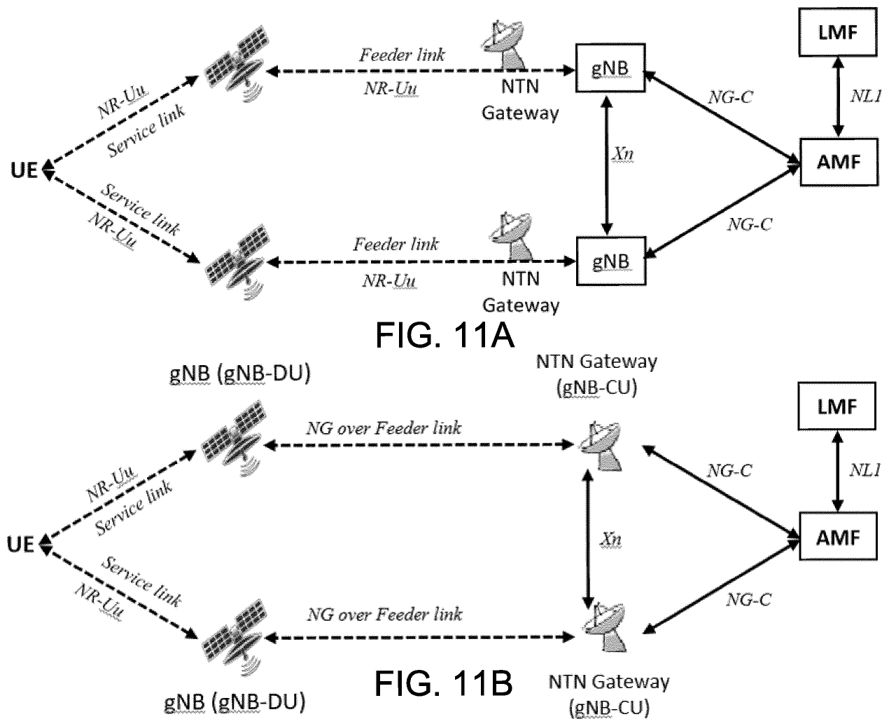

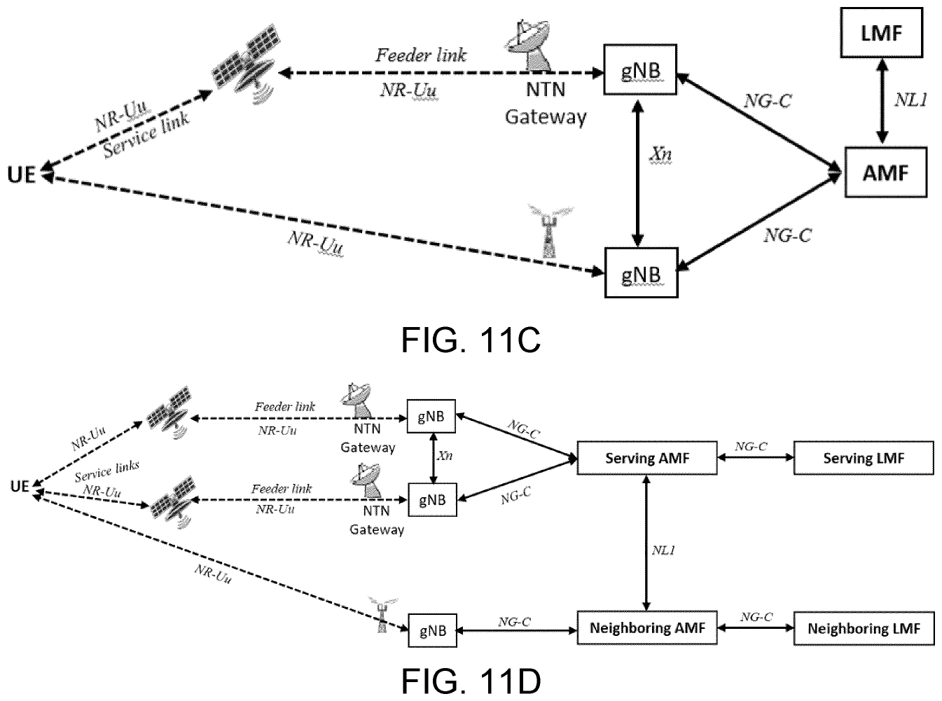

FIG. 11A illustrates a first scenario of multi-satellite connectivity using transparent payload architecture. According to scenario 1, in one embodiment, the procedures described in Embodiments 1 and 2 may be used to determine and verify the UE's location. The Master Cell Group (“MCG”) and Secondary Cell Group (“SCG”) are established, where the UE establishes initial access procedures with the gNB, part of the MCG, and thereafter the AMF may initiate the NG-RAN location reporting procedures with the MCG gNB. In other alternative implementations, the AMF may initiate NG-RAN location reporting procedures with the gNB part of the SCG, upon successful initial access and registration.

FIG. 11B illustrates a second scenario of multi-satellite connectivity using a regenerative payload architecture. According to Scenario 2, in one embodiment, the procedures described in Embodiments 1 and 2 may be used to determine and verify the UE's location. The MCG and the SCG are established, as in Scenario 1, where the UE establishes initial access procedures with the NTN gNB-DU, part of the MCG, and thereafter the AMF may initiate the NG-RAN location reporting procedures with the MCG gNB-CU and MCG gNB-DU. In another alternative implementation, the AMF may initiate NG-RAN location reporting procedures with the gNB-DU, which is part of the SCG, upon successful initial access and registration.

In this case, the gNB-CU receiving the location reporting request from the AMF may forward the same request to the NTN gNB-DU to collect the RAT-independent location information. The response may also be reported back to the AMF from the NTN gNB-DU via the NTN gateway (gNB-CU).

FIG. 11C illustrates a third scenario of TN and NTN connectivity using a transparent payload architecture. According to Scenario 3, in one embodiment, the MCG may be established with either the terrestrial gNB or NTN gNB. However, due to the propagation delays and ease of connectivity, a first priority would be to assign the terrestrial gNB as part of the MCG where the initial access procedures and NG-RAN location reporting can be enabled. In this case the NTN and gateway would form part of the SCG. Accordingly, the AMF may initiate the NG-RAN location reporting procedures with the MCG terrestrial gNB using legacy reporting procedures that rely on Cell ID course location identification and verification. Therefore, the UE's location can be verified in a straight-forward manner via connection to the terrestrial gNB.

FIG. 11D illustrates a fourth scenario of TN and NTN connectivity using Transparent Payload Architecture using different AMFs and LMFs. According to Scenario 4, each gNB may also be connected to separate AMFs and LMFs belonging to different PLMN areas. This serves as another variation of Scenario 3, whereby the procedures related to location and reporting verification may be applicable using the above described MCG and SCG configuration

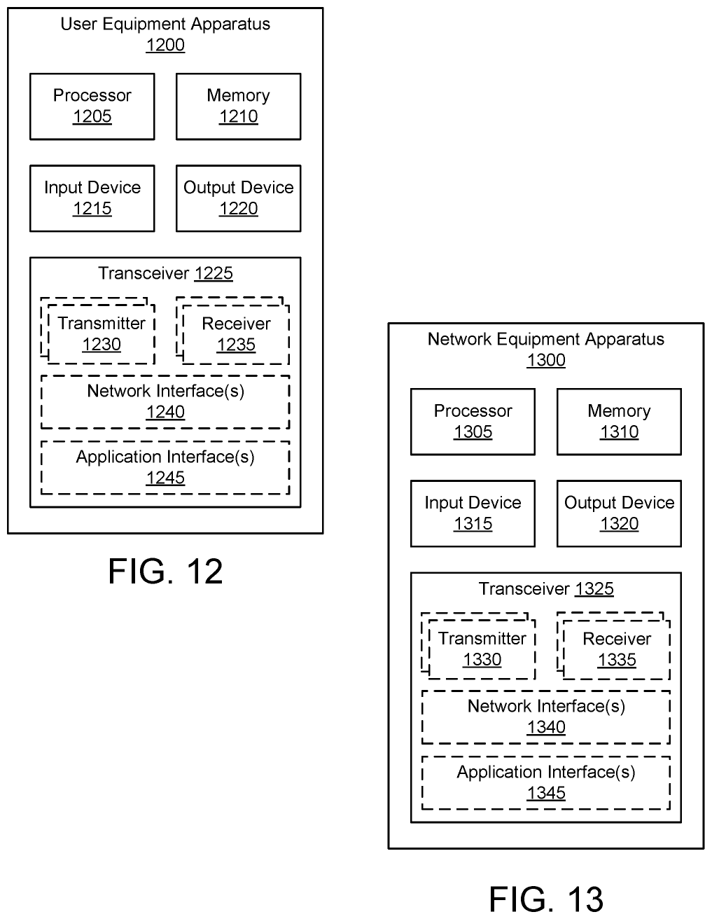

FIG. 12 depicts a user equipment apparatus 1200 that may be used for NTN-based UE location verification, according to embodiments of the disclosure. In various embodiments, the user equipment apparatus 1200 is used to implement one or more of the solutions described above. The user equipment apparatus 1200 may be one embodiment of a UE, such as the remote unit 105 and/or the UE 205, as described above. Furthermore, the user equipment apparatus 1200 may include a processor 1205, a memory 1210, an input device 1215, an output device 1220, and a transceiver 1225. In some embodiments, the input device 1215 and the output device 1220 are combined into a single device, such as a touchscreen. In certain embodiments, the user equipment apparatus 1200 may not include any input device 1215 and/or output device 1220. In various embodiments, the user equipment apparatus 1200 may include one or more of: the processor 1205, the memory 1210, and the transceiver 1225, and may not include the input device 1215 and/or the output device 1220.

As depicted, the transceiver 1225 includes at least one transmitter 1230 and at least one receiver 1235. Here, the transceiver 1225 communicates with one or more base units 121. Additionally, the transceiver 1225 may support at least one network interface 1240 and/or application interface 1245. The application interface(s) 1245 may support one or more APIs. The network interface(s) 1240 may support 3GPP reference points, such as Uu and PC5. Other network interfaces 1240 may be supported, as understood by one of ordinary skill in the art.

The processor 1205, in one embodiment, may include any known controller capable of executing computer-readable instructions and/or capable of performing logical operations. For example, the processor 1205 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 1205 executes instructions stored in the memory 1210 to perform the methods and routines described herein. The processor 1205 is communicatively coupled to the memory 1210, the input device 1215, the output device 1220, and the transceiver 1225. In certain embodiments, the processor 1205 may include an application processor (also known as “main processor”) which manages application-domain and operating system (“OS”) functions and a baseband processor (also known as “baseband radio processor”) which manages radio functions.

The memory 1210, in one embodiment, is a computer readable storage medium. In some embodiments, the memory 1210 includes volatile computer storage media. For example, the memory 1210 may include a RAM, including dynamic RAM (“DRAM”), synchronous dynamic RAM (“SDRAM”), and/or static RAM (“SRAM”). In some embodiments, the memory 1210 includes non-volatile computer storage media. For example, the memory 1210 may include a hard disk drive, a flash memory, or any other suitable non-volatile computer storage device. In some embodiments, the memory 1210 includes both volatile and non-volatile computer storage media.

In some embodiments, the memory 1210 stores data related to CSI enhancements for higher frequencies. For example, the memory 1210 may store parameters, configurations, resource assignments, policies, and the like as described above. In certain embodiments, the memory 1210 also stores program code and related data, such as an operating system or other controller algorithms operating on the user equipment apparatus 1200, and one or more software applications.

The input device 1215, in one embodiment, may include any known computer input device including a touch panel, a button, a keyboard, a stylus, a microphone, or the like. In some embodiments, the input device 1215 may be integrated with the output device 1220, for example, as a touchscreen or similar touch-sensitive display. In some embodiments, the input device 1215 includes a touchscreen such that text may be input using a virtual keyboard displayed on the touchscreen and/or by handwriting on the touchscreen. In some embodiments, the input device 1215 includes two or more different devices, such as a keyboard and a touch panel.

The output device 1220, in one embodiment, is designed to output visual, audible, and/or haptic signals. In some embodiments, the output device 1220 includes an electronically controllable display or display device capable of outputting visual data to a user. For example, the output device 1220 may include, but is not limited to, an LCD display, an LED display, an OLED display, a projector, or similar display device capable of outputting images, text, or the like to a user. As another, non-limiting, example, the output device 1220 may include a wearable display separate from, but communicatively coupled to, the rest of the user equipment apparatus 1200, such as a smart watch, smart glasses, a heads-up display, or the like. Further, the output device 1220 may be a component of a smart phone, a personal digital assistant, a television, a table computer, a notebook (laptop) computer, a personal computer, a vehicle dashboard, or the like.

In certain embodiments, the output device 1220 includes one or more speakers for producing sound. For example, the output device 1220 may produce an audible alert or notification (e.g., a beep or chime). In some embodiments, the output device 1220 includes one or more haptic devices for producing vibrations, motion, or other haptic feedback. In some embodiments, all, or portions of the output device 1220 may be integrated with the input device 1215. For example, the input device 1215 and output device 1220 may form a touchscreen or similar touch-sensitive display. In other embodiments, the output device 1220 may be located near the input device 1215.

The transceiver 1225 includes at least transmitter 1230 and at least one receiver 1235. The transceiver 1225 may be used to provide UL communication signals to a base unit 121 and to receive DL communication signals from the base unit 121, as described herein. Similarly, the transceiver 1225 may be used to transmit and receive SL signals (e.g., V2X communication), as described herein. Although only one transmitter 1230 and one receiver 1235 are illustrated, the user equipment apparatus 1200 may have any suitable number of transmitters 1230 and receivers 1235. Further, the transmitter(s) 1230 and the receiver(s) 1235 may be any suitable type of transmitters and receivers. In one embodiment, the transceiver 1225 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 1225, transmitters 1230, and receivers 1235 may be implemented as physically separate components that access a shared hardware resource and/or software resource, such as for example, the network interface 1240.

In various embodiments, one or more transmitters 1230 and/or one or more receivers 1235 may be implemented and/or integrated into a single hardware component, such as a multi-transceiver chip, a system-on-a-chip, an ASIC, or other type of hardware component. In certain embodiments, one or more transmitters 1230 and/or one or more receivers 1235 may be implemented and/or integrated into a multi-chip module. In some embodiments, other components such as the network interface 1240 or other hardware components/circuits may be integrated with any number of transmitters 1230 and/or receivers 1235 into a single chip. In such embodiment, the transmitters 1230 and receivers 1235 may be logically configured as a transceiver 1225 that uses one more common control signals or as modular transmitters 1230 and receivers 1235 implemented in the same hardware chip or in a multi-chip module.

FIG. 13 depicts one embodiment of a network apparatus 1300 that may be used for NTN-based UE location verification, according to embodiments of the disclosure. In some embodiments, the network apparatus 1300 may be one embodiment of a RAN node and its supporting hardware, such as the base unit 121 and/or gNB, described above. Furthermore, network apparatus 1300 may include a processor 1305, a memory 1310, an input device 1315, an output device 1320, and a transceiver 1325. In certain embodiments, the network apparatus 1300 does not include any input device 1315 and/or output device 1320.

As depicted, the transceiver 1325 includes at least one transmitter 1330 and at least one receiver 1335. Here, the transceiver 1325 communicates with one or more remote units 105. Additionally, the transceiver 1325 may support at least one network interface 1340 and/or application interface 1345. The application interface(s) 1345 may support one or more APIs. The network interface(s) 1340 may support 3GPP reference points, such as Uu, N1, N2, N3, N5, N6 and/or N7 interfaces. Other network interfaces 1340 may be supported, as understood by one of ordinary skill in the art.

The processor 1305, in one embodiment, may include any known controller capable of executing computer-readable instructions and/or capable of performing logical operations. For example, the processor 1305 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 1305 executes instructions stored in the memory 1310 to perform the methods and routines described herein. The processor 1305 is communicatively coupled to the memory 1310, the input device 1315, the output device 1320, and the transceiver 1325. In certain embodiments, the processor 1305 may include an application processor (also known as “main processor”) which manages application-domain and operating system (“OS”) functions and a baseband processor (also known as “baseband radio processor”) which manages radio function. In various embodiments, the processor 1305 controls the network apparatus 1300 to implement the above described network entity behaviors (e.g., of the gNB) for NTN-based UE location verification.

The memory 1310, in one embodiment, is a computer readable storage medium. In some embodiments, the memory 1310 includes volatile computer storage media. For example, the memory 1310 may include a RAM, including dynamic RAM (“DRAM”), synchronous dynamic RAM (“SDRAM”), and/or static RAM (“SRAM”). In some embodiments, the memory 1310 includes non-volatile computer storage media. For example, the memory 1310 may include a hard disk drive, a flash memory, or any other suitable non-volatile computer storage device. In some embodiments, the memory 1310 includes both volatile and non-volatile computer storage media.

In some embodiments, the memory 1310 stores data relating to CSI enhancements for higher frequencies. For example, the memory 1310 may store parameters, configurations, resource assignments, policies, and the like as described above. In certain embodiments, the memory 1310 also stores program code and related data, such as an operating system (“OS”) or other controller algorithms operating on the network apparatus 1300, and one or more software applications.

The input device 1315, in one embodiment, may include any known computer input device including a touch panel, a button, a keyboard, a stylus, a microphone, or the like. In some embodiments, the input device 1315 may be integrated with the output device 1320, for example, as a touchscreen or similar touch-sensitive display. In some embodiments, the input device 1315 includes a touchscreen such that text may be input using a virtual keyboard displayed on the touchscreen and/or by handwriting on the touchscreen. In some embodiments, the input device 1315 includes two or more different devices, such as a keyboard and a touch panel.

The output device 1320, in one embodiment, may include any known electronically controllable display or display device. The output device 1320 may be designed to output visual, audible, and/or haptic signals. In some embodiments, the output device 1320 includes an electronic display capable of outputting visual data to a user. Further, the output device 1320 may be a component of a smart phone, a personal digital assistant, a television, a table computer, a notebook (laptop) computer, a personal computer, a vehicle dashboard, or the like.

In certain embodiments, the output device 1320 includes one or more speakers for producing sound. For example, the output device 1320 may produce an audible alert or notification (e.g., a beep or chime). In some embodiments, the output device 1320 includes one or more haptic devices for producing vibrations, motion, or other haptic feedback. In some embodiments, all, or portions of the output device 1320 may be integrated with the input device 1315. For example, the input device 1315 and output device 1320 may form a touchscreen or similar touch-sensitive display. In other embodiments, all, or portions of the output device 1320 may be located near the input device 1315.

As discussed above, the transceiver 1325 may communicate with one or more remote units and/or with one or more interworking functions that provide access to one or more PLMNs. The transceiver 1325 may also communicate with one or more network functions (e.g., in the mobile core network 80). The transceiver 1325 operates under the control of the processor 1305 to transmit messages, data, and other signals and also to receive messages, data, and other signals. For example, the processor 1305 may selectively activate the transceiver (or portions thereof) at particular times in order to send and receive messages.

The transceiver 1325 may include one or more transmitters 1330 and one or more receivers 1335. In certain embodiments, the one or more transmitters 1330 and/or the one or more receivers 1335 may share transceiver hardware and/or circuitry. For example, the one or more transmitters 1330 and/or the one or more receivers 1335 may share antenna(s), antenna tuner(s), amplifier(s), filter(s), oscillator(s), mixer(s), modulator/demodulator(s), power supply, and the like. In one embodiment, the transceiver 1325 implements multiple logical transceivers using different communication protocols or protocol stacks, while using common physical hardware.

In one embodiment, the processor 1305 transmits, via the transceiver 1325, a RAT-independent location information request, the request comprising a location configuration for a NG-RAN node, receives, via the transceiver 1325, RAT-independent location information of a target UE corresponding to the transmitted location information request, the RAT-independent location information comprising a location estimate of the target UE, triggers a location server to determine a location estimate for the target UE using a RAT-dependent positioning indication, receives, via the transceiver 1325, the location estimate based on the RAT-dependent positioning indication, and performs verification of the received RAT-independent target UE location with respect to the RAT-dependent UE location estimate.

In one embodiment, the processor 1305 initiates a location request to the NG-RAN node and a location request to the location server simultaneously or in a sequential manner.

In one embodiment, the NG-RAN location configuration comprises a request for a UE location based on configured RAT-independent positioning information.

In one embodiment, the RAT-independent positioning information comprises at least one selected from the group of GNSS positioning information, Bluetooth positioning information, WLAN positioning information, IMU sensor information, altitude information, direction or orientation information, velocity estimate information, accuracy information, or a combination thereof.

In one embodiment, the processor 1305 triggers the NG-RAN node to report the target UE location information.

In one embodiment, the location report by the NG-RAN node may be based on at least one selected from the group comprising a single report, a periodic report, an event-based report, an aperiodic report, or a combination thereof.

In one embodiment, the location report by the NG-RAN node comprises a plurality of locations, each of the plurality of locations associated with a timestamp and a location estimate quality indicator.

In one embodiment, the location report comprises an error message in response to the location of the UE being unavailable.

In one embodiment, verifying the target UE location and reporting is supported for an NTN multi-connectivity scenario comprising a transparent payload connectivity option, a regenerative payload connectivity option, a terrestrial connectivity option, and a non-terrestrial connectivity option connectivity option.

In one embodiment, the network entity comprises an AMF.

In one embodiment, the processor 1305 receives, via the transceiver 1325, from an

AMF, an indication to determine a location estimate for the target UE using a RAT-dependent positioning indication, estimate the location of the target UE using the RAT-dependent positioning indication, and transmit, via the transceiver 1325, to the AMF, a response message comprising the estimated location of the target UE, a location service identifier, a positioning method that was used to estimate the location, and a timestamp of the location estimate.

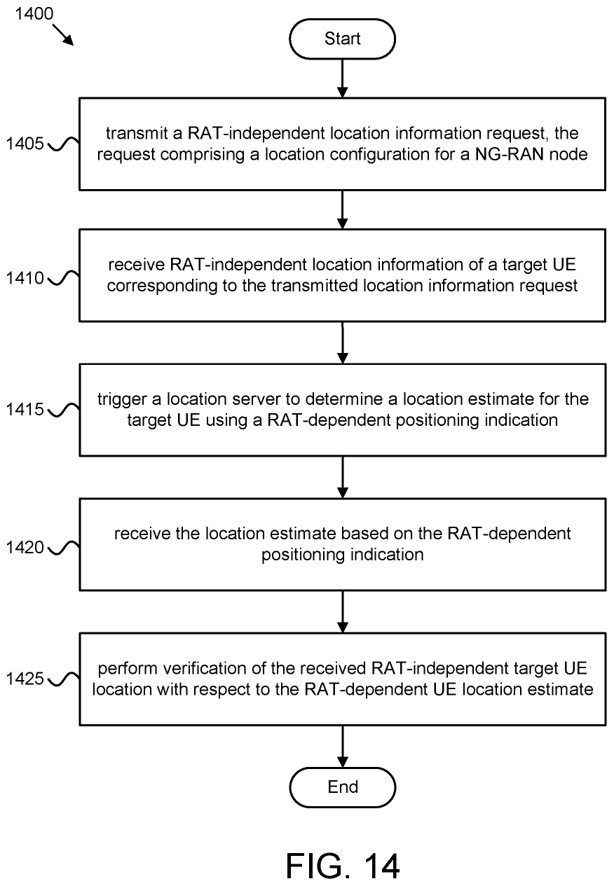

FIG. 14 is a flowchart diagram of a method 1400 for NTN-based UE location verification. The method 1400 may be performed by a network entity as described herein, for example, the gNB, base station 121, a network function (e.g., an AMF or an LMF), and/or the network equipment apparatus 1300. In some embodiments, the method 1400 may be performed by a processor executing program code, for example, a microcontroller, a microprocessor, a CPU, a GPU, an auxiliary processing unit, a FPGA, or the like. 25

In one embodiment, the method 1400 begins and transmits 1405 a RAT-independent location information request. In one embodiment, the method 1400 receives 1410 RAT-independent location information of a target UE corresponding to the transmitted location information request. In one embodiment, the method 1400 triggers 1415 a location server to determine a location estimate for the target UE using a RAT-dependent positioning indication. In one embodiment, the method 1400 receives 1420 the location estimate based on the RAT-dependent positioning indication. In one embodiment, the method 1400 performs 1425 verification of the received RAT-independent target UE location with respect to the RAT-dependent UE location estimate, and the method 1400 ends.

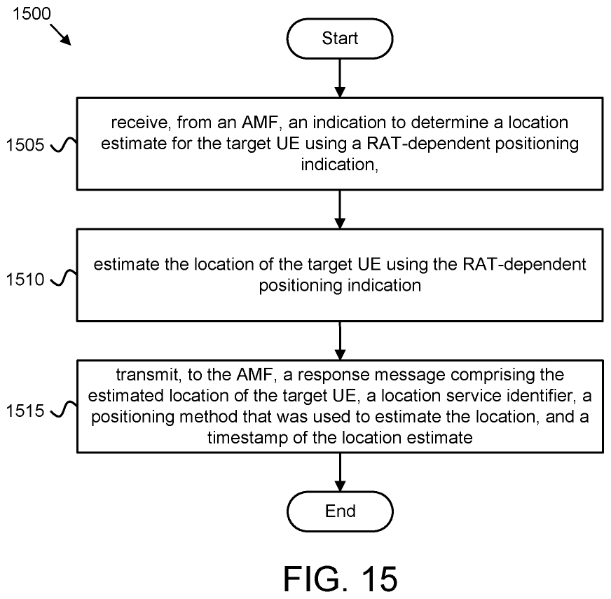

FIG. 15 is a flowchart diagram of a method 1500 for NTN-based UE location verification. The method 1500 may be performed by a network entity as described herein, for example, the gNB, base station 121, a network function (e.g., an AMF or an LMF), and/or the network equipment apparatus 1300. In some embodiments, the method 1500 may be performed by a processor executing program code, for example, a microcontroller, a microprocessor, a CPU, a GPU, an auxiliary processing unit, a FPGA, or the like.

In one embodiment, the method 1500 begins and receives 1505, from an AMF, an indication to determine a location estimate for the target UE using a RAT-dependent positioning indication. In one embodiment, the method 1500 estimates 1510 the location of the target UE using the RAT-dependent positioning indication. In one embodiment, the method 1500 transmits 1515, to the AMF, a response message comprising the estimated location of the target UE, a location service identifier, a positioning method that was used to estimate the location, and a timestamp of the location estimate, and the method 1500 ends.

A first apparatus is disclosed for NTN-based UE location verification. The first apparatus may include a network entity as described herein, for example, the gNB, base station 121, a network function (e.g., an AMF or an LMF), and/or the network equipment apparatus 1300. In some embodiments, the first apparatus includes a processor executing program code, for example, a microcontroller, a microprocessor, a CPU, a GPU, an auxiliary processing unit, a FPGA, or the like.

In one embodiment, the first apparatus includes a transceiver and a processor coupled to the transceiver. In one embodiment, the processor is configured to cause the apparatus to transmit a RAT-independent location information request, the request comprising a location configuration for a NG-RAN node, receive RAT-independent location information of a target UE corresponding to the transmitted location information request, the RAT-independent location information comprising a location estimate of the target UE, trigger a location server to determine a location estimate for the target UE using a RAT-dependent positioning indication, receive the location estimate based on the RAT-dependent positioning indication, and perform verification of the received RAT-independent target UE location with respect to the RAT-dependent UE location estimate.

In one embodiment, the processor is configured to cause the apparatus to initiate a location request to the NG-RAN node and a location request to the location server simultaneously or in a sequential manner.

In one embodiment, the NG-RAN location configuration comprises a request for a UE location based on configured RAT-independent positioning information.

In one embodiment, the RAT-independent positioning information comprises at least one selected from the group of GNSS positioning information, Bluetooth positioning information, WLAN positioning information, IMU sensor information, altitude information, direction or orientation information, velocity estimate information, accuracy information, or a combination thereof.

In one embodiment, the processor is configured to cause the apparatus to trigger the NG-RAN node to report the target UE location information.

In one embodiment, the location report by the NG-RAN node may be based on at least one selected from the group comprising a single report, a periodic report, an event-based report, an aperiodic report, or a combination thereof.

In one embodiment, the location report by the NG-RAN node comprises a plurality of locations, each of the plurality of locations associated with a timestamp and a location estimate quality indicator.

In one embodiment, the location report comprises an error message in response to the location of the UE being unavailable.

In one embodiment, verifying the target UE location and reporting is supported for an NTN multi-connectivity scenario comprising a transparent payload connectivity option, a regenerative payload connectivity option, a terrestrial connectivity option, and a non-terrestrial connectivity option connectivity option.

In one embodiment, the network entity comprises an AMF.

A first method is disclosed for NTN-based UE location verification. The first method may be performed by a network entity as described herein, for example, the gNB, base station 121, a network function (e.g., an AMF or an LMF), and/or the network equipment apparatus 1300. In some embodiments, the first method may be performed by a processor executing program code, for example, a microcontroller, a microprocessor, a CPU, a GPU, an auxiliary processing unit, a FPGA, or the like.

In one embodiment, the first method transmits a RAT-independent location information request, the request comprising a location configuration for a NG-RAN node, receives RAT-independent location information of a target UE corresponding to the transmitted location information request, the RAT-independent location information comprising a location estimate of the target UE, triggers a location server to determine a location estimate for the target UE using a RAT-dependent positioning indication, receives the location estimate based on the RAT-dependent positioning indication, and performs verification of the received RAT-independent target UE location with respect to the RAT-dependent UE location estimate.

In one embodiment, the first method initiates a location request to the NG-RAN node and a location request to the location server simultaneously or in a sequential manner.

In one embodiment, the NG-RAN location configuration comprises a request for a UE location based on configured RAT-independent positioning information.

In one embodiment, the RAT-independent positioning information comprises at least one selected from the group of GNSS positioning information, Bluetooth positioning information, WLAN positioning information, IMU sensor information, altitude information, direction or orientation information, velocity estimate information, accuracy information, or a combination thereof.

In one embodiment, the first method triggers the NG-RAN node to report the target UE location information.

In one embodiment, the location report by the NG-RAN node may be based on at least one selected from the group comprising a single report, a periodic report, an event-based report, an aperiodic report, or a combination thereof.

In one embodiment, the location report by the NG-RAN node comprises a plurality of locations, each of the plurality of locations associated with a timestamp and a location estimate quality indicator.

In one embodiment, the location report comprises an error message in response to the location of the UE being unavailable.

In one embodiment, verifying the target UE location and reporting is supported for a NTN multi-connectivity scenario comprising a transparent payload connectivity option, a regenerative payload connectivity option, a terrestrial connectivity option, and a non-terrestrial connectivity option connectivity option.

In one embodiment, the network entity comprises an AMF.

A second apparatus is disclosed for NTN-based UE location verification. The second apparatus may include a network entity as described herein, for example, the gNB, base station 121, a network function (e.g., an AMF or an LMF), and/or the network equipment apparatus 1300. In some embodiments, the second apparatus includes a processor executing program code, for example, a microcontroller, a microprocessor, a CPU, a GPU, an auxiliary processing unit, a FPGA, or the like.

In one embodiment, the second apparatus includes a transceiver and a processor coupled to the transceiver. In one embodiment, the processor is configured to cause the apparatus to receive, from an AMF, an indication to determine a location estimate for the target UE using a RAT-dependent positioning indication, estimate the location of the target UE using the RAT-dependent positioning indication, and transmit, to the AMF, a response message comprising the estimated location of the target UE, a location service identifier, a positioning method that was used to estimate the location, and a timestamp of the location estimate.

A second method is disclosed for NTN-based UE location verification. The second method may be performed by a network entity as described herein, for example, the gNB, base station 121, a network function (e.g., an AMF or an LMF), and/or the network equipment apparatus 1300. In some embodiments, the second method may be performed by a processor executing program code, for example, a microcontroller, a microprocessor, a CPU, a GPU, an auxiliary processing unit, a FPGA, or the like.

In one embodiment, the second method receives, from an AMF, an indication to determine a location estimate for the target UE using a RAT-dependent positioning indication, estimate the location of the target UE using the RAT-dependent positioning indication, and transmit, to the AMF, a response message comprising the estimated location of the target UE, a location service identifier, a positioning method that was used to estimate the location, and a timestamp of the location estimate.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1-20. (canceled)

21. A first network entity for wireless communication configured to:
transmit a request for location information associated with a user equipment (UE);
receive, from a base station, a first location estimate of the UE;
receive, from a second network entity, a second location estimate of the UE; and
perform location verification based at least in part on the first location estimate of the UE and the second location estimate of the UE.

22. The first network entity of claim 21, wherein the first network entity is an Access and Mobility Management Function (AMF).

23. The first network entity of claim 21, wherein the base station is a New Generation Radio Access Network (NG-RAN) node.

24. The first network entity of claim 21, wherein the second network entity is a Location Management Function (LMF), or Gateway Mobile Location Center (GMLC), or a combination thereof.

25. The first network entity of claim 21, wherein the request for the location information associated with the UE is transmitted to the base station, or the second network entity, or a combination thereof.

26. The first network entity of claim 21, wherein the location verification is based at least in part on non-terrestrial network capabilities of the UE.

27. The first network entity of claim 21, further configured to deregister the UE from a network based at least in part on the location verification.

28. The first network entity of claim 27, wherein the network is a Public Land Mobile Network (PLMN).

29. A method for wireless communication performed by a first network entity, the method comprising:
transmitting a request for location information associated with a user equipment (UE);
receiving, from a base station, a first location estimate of the UE;
receiving, from a second network entity, a second location estimate of the UE; and
performing location verification based at least in part on the first location estimate of the UE and the second location estimate of the UE.

30. The method of claim 29, wherein:
the first network entity is an Access and Mobility Management Function (AMF);
the base station is a New Generation Radio Access Network (NG-RAN) node; and
the second network entity is a Location Management Function (LMF), or Gateway Mobile Location Center (GMLC), or a combination thereof.

31. The method of claim 29, wherein the request for the location information associated with the UE is transmitted to the base station, or the second network entity, or a combination thereof.

32. The method of claim 29, wherein the location verification is based at least in part on non-terrestrial network capabilities of the UE.

33. The method of claim 29, further comprising:
deregistering the UE from a network based at least in part on the location verification,
wherein the network is a Public Land Mobile Network (PLMN).

34. A first network entity for wireless communication configured to:
receive, from a second network entity, a request message for location information associated with a user equipment (UE);
estimate a location of the UE in response to the received request; and
transmit, to the second network entity, a response message that includes the estimated location of the UE.

35. The first network entity of claim 34, wherein the response message further indicates a location service identifier, a method used for estimation of the location of the UE, a timestamp of the estimation of the location of the UE, or a combination thereof.

36. The first network entity of claim 34, wherein the first network entity is a New Generation Radio Access Network (NG-RAN) node, a Location Management Function (LMF), or Gateway Mobile Location Center (GMLC), or a combination thereof.

37. The first network entity of claim 34, wherein the second network entity is an Access and Mobility Management Function (AMF).

38. A method for wireless communication performed by a first network entity, the method comprising:
receiving, from a second network entity, a request message for location information associated with a user equipment (UE);
estimating a location of the UE in response to the received request; and
transmitting, to the second network entity, a response message that includes the estimated location of the UE.

39. The method of claim 38, wherein the response message further indicates a location service identifier, a method used for estimation of the location of the UE, a timestamp of the estimation of the location of the UE, or a combination thereof.

40. The method of claim 38, wherein:
the first network entity is a New Generation Radio Access Network (NG-RAN) node, a Location Management Function (LMF), or Gateway Mobile Location Center (GMLC), or a combination thereof; and
the second network entity is an Access and Mobility Management Function (AMF).
